(19) United States
(12) Patent Application Publication
(10) Pub. No.: US 2002/0055924 A1
(43) Pub. Date: May 9, 2002

(54) System and method providing a spatial location context

(76) Inventor: Richard Liming, Alexandria, VA (US)

Correspondence Address: GREENBERG-TRAURIG, 1750 TYSONS BOULEVARD, 12TH FLOOR, MCLEAN, VA, 22102, US

(21) Appl. No.: 09/761,649

(22) Filed: Jan. 18, 2001

Related U.S. Application Data
(60) Provisional application No. 60/176,489, filed on Jan. 18, 2000.

(51) Int. Cl. G06F 7/00

(52) U.S. Cl. 707/100

(57) ABSTRACT

A software and hardware architecture operating across a local or wide area network providing an integral spatial location context. Such spatial location contexts form the foundation for location-enabled systems and transactions by integrating an extensible plurality of spatial and time reference systems and encodings; an accurate and precise metadata model; persistent identification; and a flexible digital security model. This application also teaches the use of such location-enabled systems and transactions to create methods and systems for automation, transaction processing, integration, and exchange of spatially relevant information over a communications network like the Internet.

### REFERENCE TO RELATED APPLICATIONS

The present application claims priority from U.S. Provisional Patent Application Ser. No. 60/176,189, filed Jan. 18, 2000, and the teachings of said U.S. Provisional Patent Application is incorporated by reference in its entirety.

### FIELD OF THE INVENTION

The present invention relates to the fields of data and telecommunications networks, such as the Internet, and specifically concerns spatial location technologies, information search and retrieval systems, and electronic automation systems.

### BACKGROUND OF THE INVENTION

The current incarnation of the Internet was essentially created in the early 1970's, and achieved wide public adoption in the early to mid 1990's. This wide adoption is a testament to the great technological advancements and advantages of digital, packet-switched networks. This technology has provided unprecedented creation and use of, and access to, digital content on a global scale. To achieve this, significant research and effort have gone into expanding the reach of digital content transmission capabilities, along with methods for creating, formatting, and retrieving digital content.

A proliferation of companies, products, and, ultimately, standards, have resulted from this research and development, and currently provide and support this vital infrastructure. Network Service Providers (“NSP's”) such as UUNET, AT&T, and GTE, have built the transmission backbone, and Internet Service Providers (“ISP's”) such as AOL, Microsoft, and Juno, provide residential and commercial customers with access to this backbone. Software companies like Real Networks are constantly building innovative new software that adds new functionality to the Internet's data transmission capabilities, and search engines and web portals, such as Yahoo, Google, and Lycos, make using the World Wide Web (“the web”) portion of the Internet even easier. In addition, other software companies have developed tools, such as HTML editors, that make it easier for home and business users to create and format content for display on the Internet.

These users have recognized how easy it now is to create and share information, and a proliferation of web pages has resulted. While search-engines and web portals can search and retrieve such shared information based on broad queries, it is still difficult to find specific information. In addition, while standards defining how data should be transmitted from one computer to another have been in place for some time, the exchange of the intellectual portion of that data does not share such fortune. For example, companies wishing to share accounting information face significant obstacles, as each company's accounting software is likely to store its information with different field names and different table structures.

Significant research and development has been expended to solve this problem, and standards, such as SGML, have been developed that address the fundamental issues, but most of the standards developed were cumbersome and awkward, and thus did not enjoy wide acceptance. Newer standards, such as XML, seek to solve the same problem, but do so in a more structured manner than the older standards, which results in a system that is easier to use than SGML. XML allows a content author to store data in a structured manner, and also to store metadata, or data attributes, as well. XML's underlying structure permits more precise searches and facilitates data exchange based on this structure.

Geographic location technology has also made significant strides in recent years. Initially, systems such as LORAN-C or radio beacon navigation could be used to find a geographic position. However, such systems had to be within range of appropriate transmitters, and had to be in direct line-of-site to receive such signals. Thus, if a LORAN-C receiver were positioned on the other side of a mountain from a LORAN transmitter, the receiver may not be able to determine its current position.

More recently, the Global Positioning System (“GPS”) has gained wide-spread recognition and use as an accurate and ubiquitously available and reliable means for location determination. GPS uses a constellation of geosynchronous satellites to beam position information to receivers. These receivers need only receive signals from a few satellites to determine geographic positions to within a few feet.

GPS continues to expand its reach and use as the cost of receivers continues to decline. Consumer GPS receivers have come down to a price that makes them accessible to most average consumers. In addition, technology improvements are creating smaller and smaller receivers that can be incorporated into a wide range of devices, such as watches and automobiles.

More and more vehicles are being equipped with GPS and other technologies to assist operators with navigation. Typical GPS receivers can even allow a user to mark points along a path, or waypoints, and can guide users back and forth along this path. Some systems even integrate locally stored maps, providing a user with a graphical reference to their current location.

Some in the prior art have even begun allowing businesses, churches, governments, and other interested parties to have their locations represented on such maps. Users can then enter a street address or business name into a GPS receiver, and the receiver may determine a route from the receiver's current position to the desired location. However, as with other directories, such as those maintained by telephone companies, when new roads are added or businesses move, such local maps must be updated.

In fact, directories such as telephone books or Internet-based directory sites only update business location information when a business renews an advertising contract, or when a business specifically notifies the directory maintainer of such changes. Further, some directory content can come from sources that have little quality control, and thus may result in the storage of incorrect information in the directory. This can result in a misunderstanding of a vendor's location, and consequently can lead to a mistrust of such systems.

### SUMMARY OF THE INVENTION

While these classification, search, directory organization, position determination, automation, and networking systems exist in the prior art, they exist as discrete, separate technologies, rather than being unified into a cohesive system. The present invention can provide a spatial, or location, context for communications networks, such as the Internet, cable television systems, or telephone systems, by associating unique identifiers with spatial locations. The present invention may further utilize such a spatial context to enhance current classification, search, automation, and directory organization systems.

The present invention may assign unique identifiers to a device, or the present invention may use Internet Protocol (“IP”) addresses, media access control (“MAC”) addresses, telephone numbers, or street addresses as such a unique identifier. Spatial locations returned by the present invention can include, but are not limited to, a set of coordinates. Such coordinates may be based on terrestrial systems, such as radio beacon navigation systems; satellite-based systems, such as GPS; celestial-based systems, such as The World Geodetic System's WGS84 standard or North American datums such as NAD27; or other such spatial location systems.

The spatial context provided by the present invention can express geographic areas by creating a set of one or more waypoints, or by combining a waypoint with a distance. The present invention may allow association of events with certain geographic areas such that, when a receiver or other device is determined to be within a geographic region, audio, video, or other sensory-stimulating content can be presented. Presented content can include, but is not limited to, advertisements, public service information, user-created content, and user-requested content.

The present invention may determine that a device is within a geographic region through a variety of means, including integration with GPS or other spatial determining systems and by having a user manually enter such information. The present invention can integrate such information with locally stored maps, and the present invention may also integrate with modern, network-accessible mapping technologies such as those provided by Etak, MapQuest, and Mapblast. Such integration can allow the present invention to display maps and other information that is constantly up to date.

As with the prior art, the present invention may include a business directory. However, unlike the prior art, a directory maintained by the prior art may be constantly updated. The present invention can assign a unique identifier to point of sale terminals or other equipment owned by a business or other entity, and each time such equipment processes a sale or performs some other pre-defined event, the location of such equipment may be reported to a directory. By this means, the present invention can maintain an accurate list of business locations.

Such dynamic directory information, coupled with location identification equipment, can allow the present invention to easily guide a user to a given business, government office, or other desired location. This can be seen as an improvement over the prior art as many people place a value on finding nearby services; having a spatially oriented, network integrated automation capability for things such as reminders; and for control of other systems.

### BRIEF DESCRIPTION OF THE DRAWINGS

FIG. 1 is a block diagram illustrating primary components of the present invention.

FIG. 2 is a block diagram of the general logic of a user client device.

FIG. 3 is logic diagram providing additional details of the location engine, illustrated as item C in FIG. 2.

FIG. 4 illustrates a sample Geobookmark Table.

FIG. 5 illustrates a sample Client Position Table.

FIG. 6 illustrates a sample Location Context Media Table.

FIG. 7 illustrates a sample Event Queue Table.

FIG. 8 illustrates a sample service_table.

FIG. 9 illustrates a sample service_class_table.

FIG. 10. is a process flow diagram for a location-enabled service search.

FIG. 11 is a process flow diagram for a location-enabled reminder.

FIG. 12 is a process flow diagram for location-enabled automation.

FIG. 13 is a timeline diagram of a DHCP client/server message exchange.

FIG. 14 illustrates a sample IP Packet Header.

FIG. 15 illustrates a sample spatial transmission protocol exchange.

### DETAILED DESCRIPTION OF THE PREFERRED EMBODIMENT

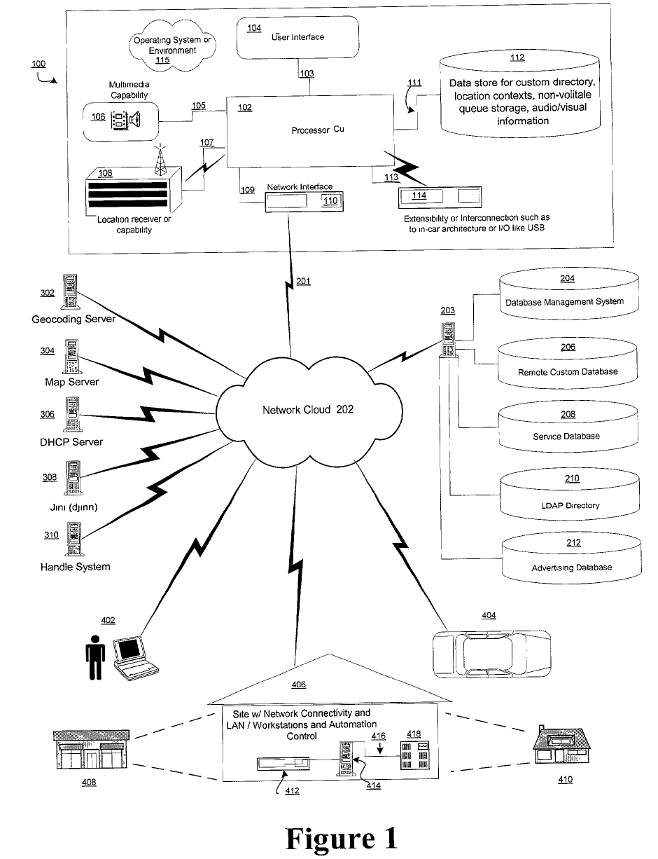

FIG. 1 is a block diagram illustrating primary components of the present invention. Block 100 (“System 100”) represents a typical, network-capable, extensible, electronic device or architecture. System 100 may comprise sub-components incorporated as built-in elements or accessible through common data channels, buses or network links. These sub-components may include, but are not limited to, a microprocessor or other data processor (Block 102), a user interface (Block 104), a multimedia or audio-visual device (Block 106), a location determination device (Block 108), a network access device (Block 110), and a data storage sub-system (Block 112).

Processor 102 (“PA102”) may comprise one or more central processing units (“CPU's”); a high-speed, short-term data storage means; an input-output or bus controller; a lower-speed, permanent or semi-permanent data storage means; and operating system software or operating environment.

User interface 104 may comprise a visual display, such as a CRT or LCD, and data entry or operational controls, such as buttons, dials, or keypads. User interface 104 may also allow voice control through voice recognition and/or speech processing. Although illustrated as a physical component part of System 100, the user interface can be made available over a communications link or network connection. Such an interface is common with network servers and routers, which may have their own graphical user interface (“GUI”) or command line interface (“CLI”), a built in Web server or Windowing system like the X windows system, or allow for these software components to be installed to provide an interface over such a channel.

User interface 104 may interact with System 100 by accepting user inputs, such as search criteria, waypoints, custom directory entry descriptions, system settings including units of display, system controls, alert selection, controls for the recording of audio/visual information, and other such functions. User interface 104 may present output from System 100 components, such as search results, advertising content, location relevant media, component status information, location information, network connectivity status, and other, similar information.

Multimedia Device 106 represents multimedia functionality for recording and playback of audiovisual information. Multimedia Device 106 may comprise a microphone, speaker, video camera, video display, or a combination thereof. Information recorded via Multimedia Device 106 may be transmitted, stored in, and retrieved from data storage sub-system 112 through Processor 102. Information recorded via Multimedia Device 106 may be transmitted over a network to or from remote data systems, such as Database Management System 204 (“DB204”), via Network Interface 110 over link 201.

Geographic location determination capability (“GLD 108”) may determine from reasonably accurate to precise geographic locations in near real-time or real-time. This may be equivalent to location determination capabilities of modem GPS equipment, such as that made by GARMIN Corporation. GLD108 may also use alternative location determination methods, such as LORAN, either in combination with or instead of GPS.

Such geographic location determination equipment may be built into System 100, or take the form of separate, hand-held receivers. GLD108 may also be integrated into other systems, such as modem automobile or flight navigation systems.

Network Access Device 110 comprises a wireless or wired communications means, such as Ethernet or other network interfaces like microwave or cellular devices. Such communications means may include, but are not limited to, Internet capable cellular phones; Bluetooth enabled devices, such as some cellular telephones; wireless portable computing devices, such as 3com's Palm VII connected organizer or RIM's Blackberry; wireless modems, such as Metricom's Ricochet technology; or wired access such as a home or business Internet connection. Internet connections may include, but are not limited to, Ethernet or GIGE adapters, DSL modems, ISDN terminal adapters, CSU/DSU and router combinations, satellite systems, cable television modems, traditional telephone modems, or other common public and private network access methods such as those supporting other protocols like ATM or MPLS.

Data storage sub-system 112 (DS112) may be a typical permanent or semi-permanent storage method, similar to those in modern computing and other electronic devices configured to read and write data. DS112 can include readable, erasable, writeable, and re-writeable media or related components. Examples of such data storage equipment include hard disks; removable media such as a floppy, Superdrive, or Zip drive; and memory cards similar to flash memory and SmartMedia cards.

Each System 100 component may itself be comprised of hardware, software, or a combination of hardware and software. System 100 components may communicate with other components through a data link, bus, wired or wireless network connection, or other data communications channel, as illustrated by Lines 103, 105, 107, 109, 111, and 113.

As illustrated by line 113, System 100 may also communicate with external devices, such as vehicle navigation systems, media players, personal computers, personal desktop assistants (“PDA's”), or other such devices (Block 114). Communication between external devices and System 100 may be facilitated through a data bus; network, parallel, serial, universal serial bus (“USB”), or infrared ports; wireless modem or wireless network connections; or other such communications methods. Such communications may include transmission of content and commands to such devices for immediate playback or for storage and playback at a later time.

While a preferred embodiment of the present invention integrates all System 100 functions into a single, stand-alone device, alternative embodiments are also envisioned. Such embodiments include, but are not limited to, automotive information systems, network access equipment, PDA's, cell phones, and personal computers may be readily instrumented to work as part of System 100.

In some such embodiments, System 100 may be implemented without location detection capabilities or other components illustrated in FIG. 1. For example, a home computer or other stationary or semi-permanent device may not need location detection capabilities. However, an ability to translate a geographic identifier, such as an address, into a more specific identifier such as geographic coordinates like latitude and longitude may be advantageous, even in stationary or semi-permanent configurations such as with laptop computers. Unlike their stationary and semi-permanent counterparts, it may be more advantageous to instrument those devices which are more mobile, such as PDA'S, laptop computers, cellular telephones, and the like, with automated location determination capabilities.

By way of example, without intending to limit the present invention, one alternatively envisioned embodiment, used in an automobile, may utilize the MobileGT Architecture. MobileGT is a joint venture of Motorola, QNX Software Systems Ltd., IBM, and Embedded Planet, and is targeted for automotive driver information systems. Another embodiment envisioned involves a more traditional processor/operating environment, as found in many forms in network capable, wired or wireless devices currently available or in development. Examples of such devices include typical personal computers based on Microsoft, Sun, Linux, or Apple operating systems and various processors from Intel, Sun, and Motorola; 3Com's Palm devices; consumer electronics devices based on the Microsoft Windows CE or Java operating systems or other operating environments such as the QNX Neutrino; wireless Web enabled telephones, such as the Qualcomm “pdQ Smartphone”; and Internet capable cable television or similar set-top boxes.

It is a goal of the present invention to provide for the incorporation of maps relevant to location contexts by incorporating a network accessible map service such as the one provided by Etak, Inc. at http://www.geocode.com or by other providers like MapQuest (http://www.mapquest.com), and Mapblast.com.

As a device is moved, or internal System 100 processes are otherwise triggered, location context events stored in an event queue acting as part of System 100 can interact through PA102 to execute processes or provide constraints that determine such executions. Processes executed through PA102 may involve retrieval of stored content from data sub-systems 112 or 204, and transmission of such content to Multimedia Device 106, User Interface 104, or externally connected devices (Block 114). User input at User Interface 104 may control recording, playback, and transfer of audio-visual information to and from Multimedia Device 106, as well as other devices, such as a home computer or remote storage device.

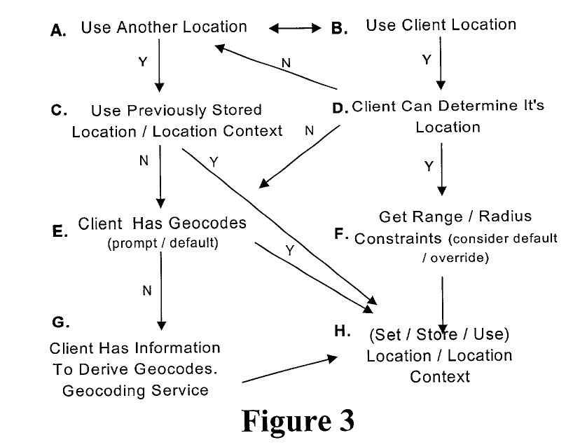

To achieve geographic location translation, the present invention may utilize geocoding. Geocoding may allow postal addresses, area codes, or other region-specific information, to be translated into more precise geographic coordinates. GC302 in FIG. 1 represents a network accessible geocoding facility such as the one provided by Etak, Inc. currently available on the Web at http://www.geocode.com. The preferred embodiment can implement several methods for geographic determination and provide for GLD108 to interact with PA102 to implement a hierarchy of preferred methods for geographic position determination and use, as outlined in the logical process diagram, FIG. 3. One aspect of a preferred embodiment may allow a configurable hierarchy. Manual entry of location specifiers such as coordinates may also be used, however a preferred embodiment would typically require these coordinates to be valid specifiers.

Element 202, in the center of FIG. 1 is a “network cloud”, which encompasses a combination of devices, connections, and protocols supporting internetworking of components not ordinarily directly connected to System 100, but rather available as network resources and systems.

One aspect of the present invention includes a mechanism for automated and/or dynamic configuration and/or service location. This aspect provides a method for clients desiring use of spatially relevant services or information to automatically be configured with little or no human intervention to locate and utilize or participate in the spatial service on the network. Such services may be accessed at boot time or at connect time. This aspect of the present invention may be accomplished using the Dynamic Host Configuration Protocol/Boot Strap Protocol(DHCP/BOOTP), Sun Microsystems' Jini Technology, and/or Service Location Protocol. The technologies or technologies providing equivalent functionality may be used individually or in combination in order to achieve the desired effect to achieve.

Block 306 (“DHCP306”) represents an RFC-2131 Dynamic Host Control Protocol (“DHCP”) server or similar functionality. DHCP provides a framework for passing configuration information to hosts on a TCP/IP network. It is based on the Bootstrap Protocol (BOOTP), adding the capability of automatic allocation of reusable network addresses and additional configuration options.

Block 308 (“JINI308”) represents a Sun Microsystems' Jini Connection Technology functionality. In FIG. 1, JINI308 is illustrated as a single server, however Jini is a distributed protocol or architecture. Jini technology allows devices to automatically locate and participate in network services, and includes other features, such as a transaction model and flexible security. Jini technology describes a collection of devices, or federation, that can talk to one another and advertise and share services automatically. These features are called Lookup, and “Discover and Join”. For example a Jini service may allow a visitor to a company to plug a device, such as a PDA, into a network and auto-discover a nearby printer without knowledge of the office's print servers or printer names.

Jini's design generally has an enterprise reach, that is to say serving a Local Area Network or perhaps a wider network of a particular company or enterprise, as opposed to the Wide Area Network of the Internet. However, used in combination with other means such as DHCP and/or persistent naming capabilities like those provided by The Handle System, a wide-area reach can be achieved.

Another aspect of the present invention may incorporate a persistent naming capability such as a Domain Name System (“DNS”). A DNS may allow mapping of IP addresses or other unique identifiers to easy to remember alphanumeric strings. Additionally, such strings may point to a new identifier or identifiers if a new system is brought online or other configuration changes occur.

While a DNS provides some measure of persistence in locating network resources, there are still persistence problems created when a company changes its domain name or declines to continue to pay to have its name reserved. The present invention can implement a persistent naming mechanism that provides persistent identification of network objects as the network or those objects change in place or in time.

A system implementing such a persistent naming function is illustrated in FIG. 1 by Block 310 (Handle 310). Handle 310 can provide universally unique and persistent service points such as pointers to spatial service servers, providers and Internet resources. The Handle System is a product of the Corporation for National Research Initiatives (“CNRI”) aimed at an improved persistent naming authority.

Database Management System 204 (DB204) is an information management server platform or similar computing component which can include a server with a data storage and network connectivity, along with server software designed for effective structured information management. In a preferred embodiment, DB204 may include a relational database management system, such as Oracle 9i, by Oracle Corporation, or Sybase Adaptive Server, created by Sybase; an LDAP type Directory, such as Netscape's Mission Control or OpenLDAP's “OpenLDAP Suite”; and a computer system (processor/operating system), such as a SUN UltraSparc 4000 running the SOLARIS operating system, or a server with an Intel or similar microprocessor running Linux or Microsoft Windows NT operating systems. SD202 may represent any DBMS functionality including, but not limited to, a relational database management system (“RDBMS”), a Directory service, an object database, or other modem system providing information management capability.

DB204 can also provide a platform for additional server software, such as Web and file transfer protocol (“FTP”) server software, Network Time Protocol daemons such as xntpd or other precise time system control software, and custom server software, such as custom spatial location server software. DB204 also represents a network accessible system which may have its own time source, such as a GPS receiver or more accurate clock, such as a stratum 1 time source.

Components of SD202 may run on a single computer, each component may run on separate computers, or components may be distributed across multiple computers. Through a combination of database, directory, and computer systems, SD202 may provide effective and efficient data storage, organization, and retrieval in a manner that will be readily understood by those skilled in the art of information management systems.

Database Management Systems 206, 208, 210, and 212 are also DBMS systems like DB204. DB204 illustrates a generic, network accessible DBMS and Directory Server architecture. Blocks 206, 208, 210, and 212 are included in FIG. 1 to aid in the description of a preferred embodiment, but these systems may be components of the same system.

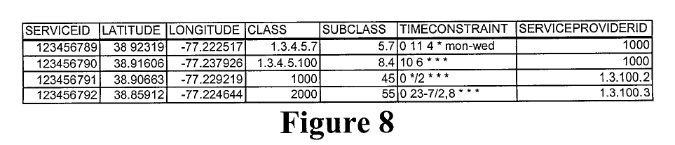

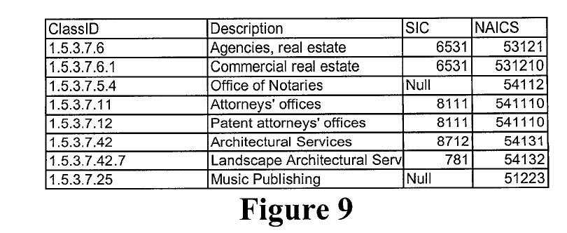

DBMS206 is a remote database which, in a preferred embodiment, can store items that may also be stored in client local data subsystem DS112, but which may also provide a remote storage means. A remote storage means may store data for clients with little or no local data storage, or for backup and sharing of items such as location contexts and geobookmarks, and content and events related to such items. DBMS 208 is an instance of DBMS204 organized in a manner which can support directory and service search functions of the present invention, and may consist of a database for holding supporting tables such as service_directory, illustrated in FIG. 8, and service_class, illustrated by FIG. 9.

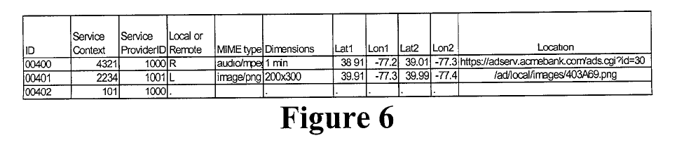

DBMS 210 is an LDAP server, providing information storage and retrieval functions typically associated with a distributed Directory Service, such as directories of services, products, businesses, and related items. DBMS 212 is an instance of DB204 which can store relevant media content and related tables. In a preferred embodiment, DB204 may be arranged for storage of location relevant media content and related tables, such as Location Context Media Table, illustrated in FIG. 6.

Block 406 (“ST406”), Block 408 (“ST408”), and Block 410 (“ST410”) may be a home, office building, or telecommunications facility with a network capability, illustrated by Network Access Device 412 (“NAD412”). ST406, ST408, and ST110 may contain computing facilities (Block 414) which may be similar to DB204, or may more closely resemble traditional servers, workstations, personal computers, and set-top boxes. ST406, ST408, and ST410 may contain home or building automation capabilities, based on standards such as X10, or other computer controlled automation systems for controlling heating, ventilation, and air conditioning (HVAC); an oven, video cassette recorder (VCR), or stereo; a security system; and other commonly controlled building and home components or networked devices. In a preferred embodiment, ST406, ST408, and ST410 may also contain a System 100 device or similar or capabilities.

As illustrated by Blocks 402 and 404, System 100 may also be incorporated into various, more mobile devices, such as laptop computers and vehicles. A preferred embodiment of the present invention provides a unique utility in applicability across stationary, mobile and semi-mobile configurations. The present invention provides for a hierarchy of configurable location methods, from automatic to manual, with defaults, prioritization, and fail-over. By way of example, without intending to limit the present invention, a user may use the default automatic mode when an onboard GPS receiver provides system location context, but may switch to manual entry if a GPS fails to work.

The present invention may also allow storage of named proximity waypoints, or geobookmarks. Stored geobookmarks can provide a desired location context for a spatially relevant information service. The present invention provides for the use of spatial information across applications, from Web searching to asset management, thereby improving over the prior art.

By way of example, without intending to limit the present invention, users cannot currently utilize spatial information across a plurality of web sites. Thus, even if a user enters a home address or zip code at a bank's website to find local ATM machines, a user must still reenter their address at a website to find a dealer for some product, such as bicycles. Today, users may even be required to reenter such information on the same vendor's page each time they return, even if the location context of their search is the same. Yet, the same information can often be used for many uses, which is an object of the present invention.

The present invention provides for the seamless, platform-independent sharing of geobookmarks across devices, services, and applications. The present invention further provides sharing of geobookmarks among technologies and implementations (stationary, mobile, semi-permanent), including optional, events or content associated with such geobookmarks, such as audio, video, or maps.

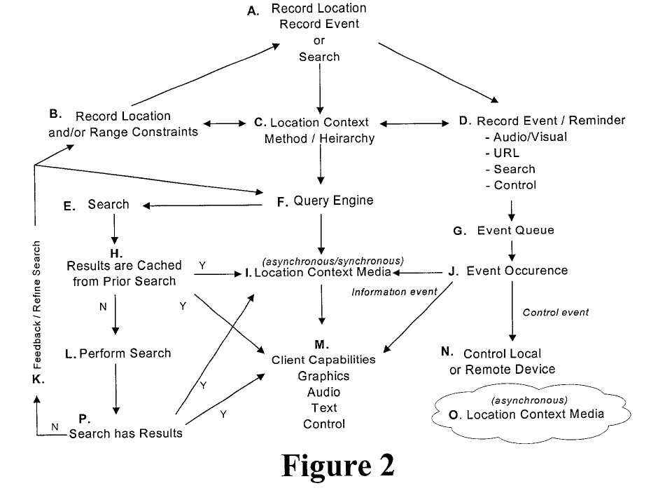

FIG. 2 is a logical diagram illustrating a preferred client implementation of a System 100 device. Such a client machine can incorporate location contexts with other items such as events and directory queries. FIG. 2 is provided for enabelment and best-mode purposes, and is not intended to limit the invention to this process.

FIG. 3 is an expanded view of a portion of item FIG. 2, specifically item C, Location Detennination Process, and illustrates logic which may be used in a preferred embodiment for various means of location determination. These location determination means may include, but are not limited to, automatic determination, such as through GPS or LORAN systems; such as through geocoding or other such systems, and manual processes. FIG. 3 further illustrates steps for selecting a location context for a given task or use.

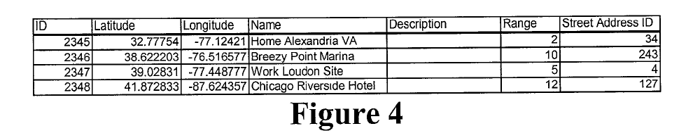

FIG. 4 illustrates a data table, Geobookmark Table, which can provide an organization mechanism for recording location contexts in memory or on media. One aspect of a preferred embodiment of the present invention can allow extensive geobookmark interaction, configuration, storage, sharing, and transmission. This table illustrates a basic data table design supporting these capabilities.

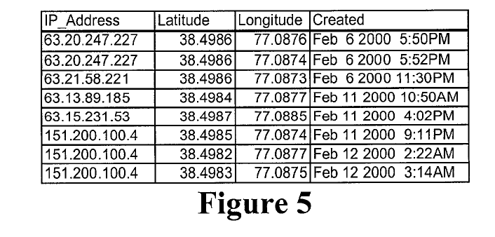

FIG. 5 illustrates a sample Client Position Table (CPTable). Tables such as CPTable can associate client system network addresses with location contexts including, but not limited to, current or previous client locations, and to store such contexts. CPTable illustrates a table for storing such items as part of a preferred embodiment for recording client positions and network addresses.

In a preferred embodiment, common CPTable fields can store information such as IP Address; Location Context Parameters, such as Latitude and Longitude or others; the time at which information was received, modified, or created; hostnames and DNS domain names; other unique record identifiers; and other related data fields. This table illustrates a preferred embodiment of a client position and network address recording means, and is not intended to limit the present invention. For example, in an alternative embodiment, other storage designs, such as binary encodings, may be used, or additional information may be recorded. CPTable may be stored in a database systems such as DB 204.

FIG. 6 is an illustration of a Location Context Media Table (LCMTable). It is an object of the present invention to provide a method for delivering location relevant media to clients. This may be achieved by storing content or pointers to such content, along with spatial or geographic areas of relevance, in a table. Such a table can then be compared to current client positions and other positions, such locations in which a user of a client device may be interested. By performing such comparisons, content of interest may be identified, and such content may be presented to a user when a user is located within the location constraints defined as an area of relevance with respect to such content.

LCMTable is an example of such a table, and illustrates a preferred storage means. LCMTable is not meant to constitute the only possible design, but rather illustrates key elements of such a table as part of a preferred embodiment. For instance, if location sensitive media is to be transmitted, it may be desirable to have a more sophisticated design that includes other fields, or further normalizing the table in a manner that may add additional features. Such features may include the ability to associate content with multiple location contexts. LCMTable may be stored in a database system like DB 204, or DB 212.

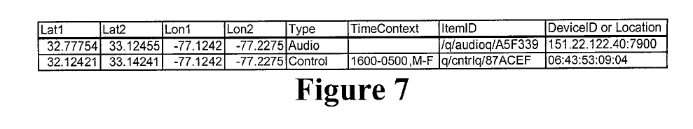

FIG. 7 illustrates a sample Event Queue table. It is an object of the present invention to provide location context triggered automation through the association of location contexts with a range of items such as audiovisual content, and other processes. FIG. 7 illustrates a preferred embodiment of a data table designed for such associations. Alternatively contemplated embodiments may include additional fields, depending on specific implementations. Such fields may include, time constraints for content presentation or event durations, or those required for further normalization of an Event Queue table, such as associations between multiple events and a single location context, or multiple location contexts with one event. An event queue table may be stored in a database system such as DB 204.

FIG. 8 illustrates a preferred embodiment of a service table. Service_table can contain a list of categorized or classified services and their geographic location and/or availability. Service_table may store information about SERVICE IDENTIFIERS, SERVICE LOCATION IDENTIFIERS, SERVICETYPE or SERVICECLASS or category SUBCLASSES, which are typically more specific sub-categories, SERVICE AVAILABILITY TIMES, and SERVICE PROVIDERS. The SERVICEID field may uniquely identify each row or service, by type of service, location and provider or OID (object id) number. The OID may be an ITU-T recommendation X.208 (ASN.1) style OID. This is the method for IANA (www.iana.org) private enterprise numbers. A basic example would be that if Acme Company was identified by 1.7.5 then a given service or product of the company may be identified by 1.7.5.3 and a different service by 1.7.5.4. Type of service may be defined by CLASS and SUBCLASS fields, which may be numeric ids relating to another table for normalization purposes, identified as service_class_table, containing service classes or categories, and a CLASSID field which may be used as a key field.

Such classifications may be used in conjunction with, may be mapped to, or actually be industry standard classifications such as SIC or NAICS codes. Additionally, the present invention may include items other than services, such as real estate or products. In a preferred embodiment, such additional items may also be so categorized an organized, and may utilize industry standard codes, such as Universal Product Codes (“UPC's”) or newer NAPCS, or mappings between said items and other system identifiers. Such design, classification, and mapping will be readily understood by those skilled in the art of information management. Service_table may be stored in database systems such as DB 204, DB208, or in an LDAP server such as DB 210.

FIG. 9 illustrates a sample data table, service_class, which illustrates a preferred embodiment of a table supporting item classifications, as described in the previous description for FIG. 8. This table may also be stored in a database system such as that provided by DB 204, DB 208, or DB 210.

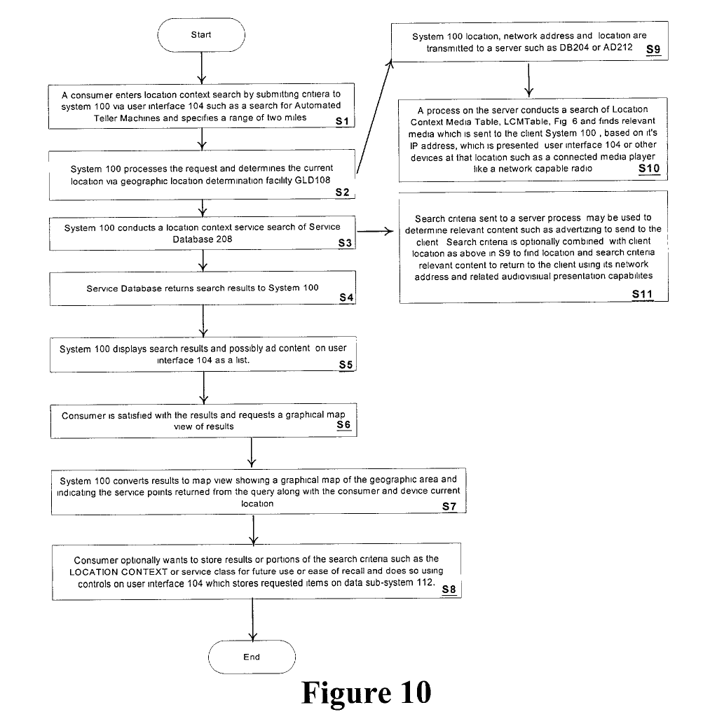

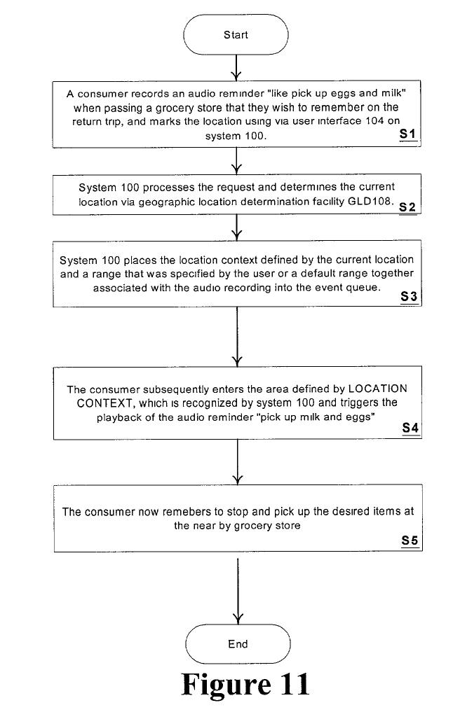

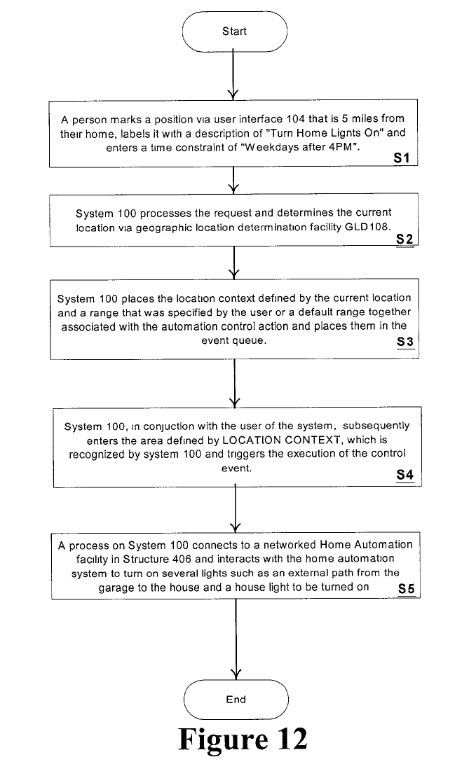

FIGS. 10 through 12 are flow charts illustrating preferred embodiments of several anticipated applications of the present invention. These applications include location relevant search, reminder automation, and remote control automation, respectively.

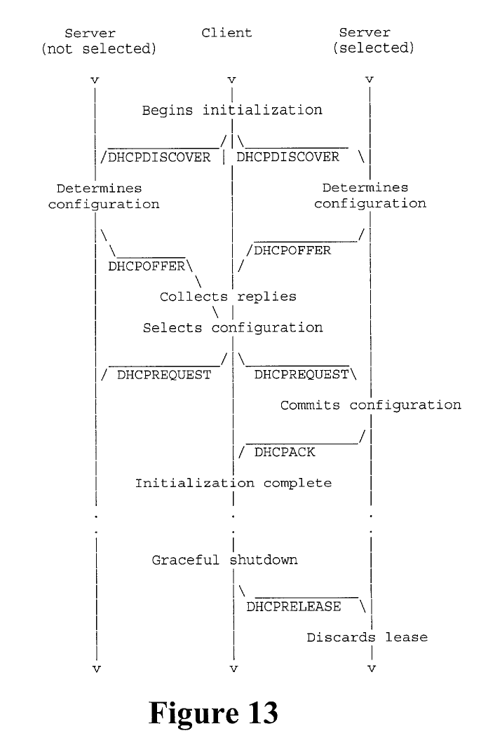

FIG. 13 is a timeline diagram of a DHCP client/server message exchange. FIG. 13 illustrates specific client server request and response messages and shows where in this process a client would receive an offer (DHCPOFFER) containing configuration information from the DHCP server.

As previously discussed, the present invention supports a plurality of applications across multiple disciplines and uses. However, it is helpful in describing aspects of the present invention to distinguish two general types of use. The first of these types of use is one in which a user typically interacts with a client device providing a System 100 capabilities. The other, more autonomous of these use types predominantly involves interactions between systems or devices, wherein at least one system has implemented components of System 100.

For example, a system centric method may not typically utilize a permanent local interface. Such a system centric method can be illustrated by envisioning the present invention implemented with servers and routers, which typically have a shared local console (usually textual rather than graphical), which is used only intermittently. Thus, a primary means for configuring and adjusting system centric devices is commonly provided via a network interface, which is often a text based CLI, such as with Cisco routers. A system centric implementation can be contrasted with a user-oriented system, in which a local user interface may be a primary interface for controlling a device, and may be very frequently.

While current system centric devices do provide a user interface, most do not provide multimedia capabilities, although certainly applications such as security and monitoring could benefit from these features. Discussions of a preferred system centric implementation of the present invention may approach its implementation from a network management scenario, and therefore will not focus on a user interface to the same extent as a user-centric discussion. However, both methods may utilize key elements of a preferred embodiment, and a division between user centric and system centric is made here purely simplify descriptions of such implementations.

A user centric embodiment of the present invention provides for robust user interaction and configuration control via a user interface. In a user-centric model, it is common for a user to determine, mark, store, share, and exchange multiple spatially relevant geobookmarks, and to utilize them across a plurality of functions and uses. It may also be common for a user to use multimedia functionality, such as Multimedia Device 106 of in FIG. 1, to record and play content associated with location contexts. A user interface may also be used as a typical content delivery mechanism, such as a Web browser or mail client, or for the reception of digital audio and video streams as with a traditional radio and television or set-top box.

By contrast, a system centric model is typically concerned with the location of a given system, and thus location context marking is typically less relevant. Instead, a system centric model may provide additional management and configuration tools, which may be conducted over a network via protocols such as via Trivial File Transport Protocol (TFTP) and/or SNMP.

In both user centric and system centric models, it is a goal of the present invention to store location-based information about any System 100 systems, such as a client device, in a database. It is common for this information to include the IP address of the system, its location descriptors, the time the location is determined and the time the information is received or recorded, and the method by which the location descriptors or context was determined.

The system may store the current client location, and the system may store other location context information. Such stored location context information may not be the location of the system or even a location where the system or its user has visited, but may be other contexts, such as a location that was used for a location context directory search, or other items. Additionally, other information may be determined, transmitted, or stored, such as but not limited to a system's host and domain name. Such information may typically be stored in a data table similar to CPTable, illustrated in FIG. 5.

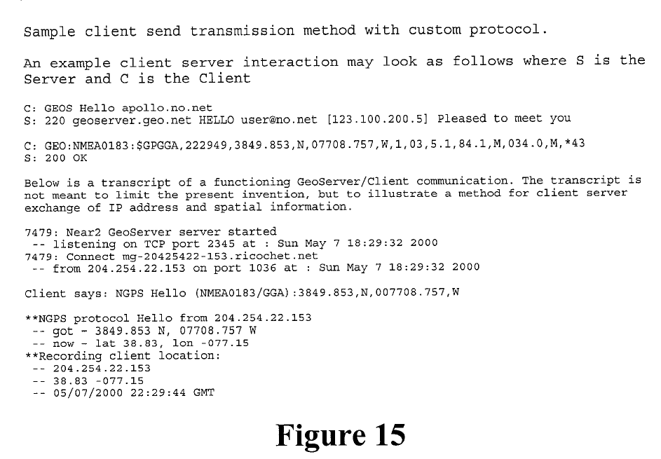

The present invention supports several spatial information transmission methods, which can be divided into two broad categories, traditional protocol methods and packet header methods. A spatial transmission method based around traditional protocol methods may transmit information as part of a message in text or binary form. Examples of this method include incorporation as part of an URL; as a field of a message header or body; as a document cookie; as an e-mail header or body; and via direct transmission as a message of a custom protocol designed for this purpose. An example of a custom protocol exchange is illustrated by FIG. 15.

In one contemplated embodiment, a client may be configured to continuously send position information to a server as quickly as location determination occurs. Testing has shown that handheld receivers, such as those manufactured by the Garmin corporation, will provide position data streams approximately once per second. In an alternative embodiment, a client may be configured to send position information at an interval. For example, a client instructed to send position information at a rate slower than its ability to resolve or send location information. Such rates may vary depending on client implementation type, and may range from once per second to once a week or longer. A client may also base server updates on locally stored position information, such that server updates only occur when a client detects location change.

In an alternatively contemplated embodiment, a client may be polled for position information. That is, a server may drive information exchanges by contacting a client and asking for location information.

A server may also function as an intermediary between client devices and other systems, using a method commonly called publish and subscribe. In this method, a client machine can publish position or other information to a server, and other systems connect to a server and subscribe to such published information.

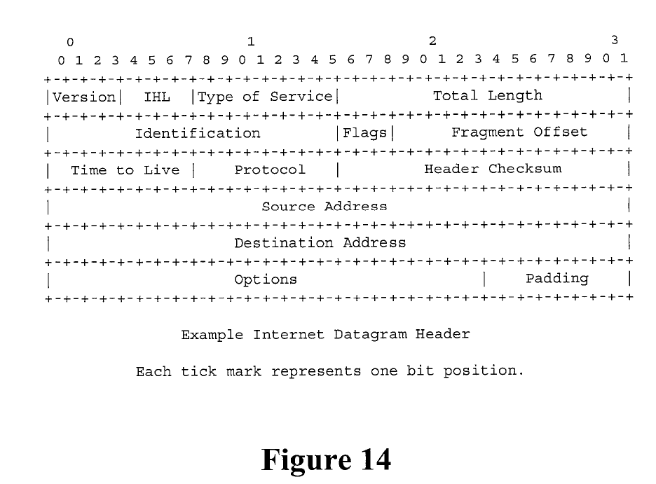

In addition to these traditional protocol and client server category of methods, an alternative embodiment of the present invention provides for inclusion of spatial information in network packet headers, such as, but not limited to, Internet Protocol Packet Headers and Transmission Control Protocol Headers. Such packets are part of widely used protocols, with a well defined structure that includes items such as a source IP address, a destination IP address, and other information, including Port number, Type of Service, Time to Live, Window Options, and Checksums. In addition, such protocols provide an “Options” section, which allows a packet to contain additional information. The structure of a typical IP packet header is illustrated in FIG. 14.

Incorporating spatial information into packets at a source device, or in intermediate devices in a transmission, can provide another means for conveying spatial information. Packet-based spatial information can also provides a means for precise geographical mapping of network equipment, such as servers, routers, bridges, and gateways. Packet-based spatial information can also allow the determination of geographic transmission paths, and geographical network. Such maps are not possible using current technology.

There have been and continue to be significant attempts at measuring spatial or geographic aspects of the Internet, such as the core Autonomous System (“AS”) mapping efforts of the Cooperative Association for Internet Data Analysis (“CAIDA”). However, such mapping efforts do not provide a true geographic representation of transmission facility locations or data paths, but rather base their information on the address or location of a network provider's home office or registered office, which may have little relationship to the path of Internet datagrams.

In embodiments implementing a packet header-based method, construction or modification of packet headers would be required to include or extract a message payload as is common in IP stack software. Implementations of both connection-oriented and connectionless communications, such as TCP/UDP, may be used to transmit spatial information separately or in combination.

The following is a description of preferred embodiments that utilize the physical aspects of System 100 depicted in FIG. 1. The present invention essentially provides a spatial context across multiple network access methods and devices, both with and without an attached GPS, for stationary, mobile, and semi-mobile scenarios.

It is an object of the present invention to provide a means for the system to distinguish between stationary and mobile uses and between automatic (GPS), and manual or semi-manual geocoding based location determination methods. In keeping with this, one aspect of the present invention can associate spatial location identifiers with one or more network address, such as an IP address, by a plurality of methods used separately or in combination.

Using the continuous transmission method outlined above as an example, a client may connect to a server, such as DB 204, when network connectivity is achieved. A client may then transmit a continuous stream of position updates to such a server. A server can store these positions in a data table, such as CPTable, illustrated in FIG. 5. Client IP addresses or other unique identifiers associated with a client may also be stored in DB 204, as may other data, such as the current time.

A server may assume that a client implementing a continuous transmission method in which a client spatial location changes is equipped with a GPS or other location determination equipment. Such an assumption is reasonable, as a client may not be capable of determining a change in location without such equipment. Thus, for example, location based triggering mechanisms and location based service search mechanisms or processes may search CPTable table to identify recent entries by the same client. If such recent entries are found, they may reasonably be concluded to be the position of the client. Such assumptions may assist the present invention in creating a more seamless user experience, as the present invention may periodically prompt a user for a current spatial location if a GPS or other location determination device can not be detected.

The preceding example should not be construed as limiting the present invention to this method, as there are other methods, such as a client/server message exchange, as well as added levels of sophistication that may be incorporated, such as secure signatures.

By way of a further example, without intending to limit the present invention, a client may connect to a server via a Web browser to initiate a search or other location relevant action. Messages from clients with location determination devices attached may only slightly differ from messages from clients without location determination devices. Both types of message consist of a start-line, zero or more header fields, an empty line indicating the end of the header fields, and possibly a message-body. This defined structure makes it easy for processes to separate the header from the body and parse these components separately. Additionally, the header fields are generally simple text with a line beginning with a field name, then a colon ‘:’, followed by the field value. This structure also makes it easy to parse to extract header fields and values by a variety of means, including Common Gateway Interface (CGI) programs.

When a client equipped with a Web browser connects to a Web server, client messages typically include a header. Such a header may include a number of fields, including the client IP address, and an optional header field called a Cookie, which may be used to store persistent but mutable information on the client. Such information may be stored in a data store within a current client Web page document, and such information may be communicated to servers or server processes.

An aspect of a preferred embodiment of the present invention may use such a Cookie to transmit location context information and to store it on the client and in a database, so that a user of the system will not have to repeatedly enter location information from use to use and from session to session. This information may also be used as a default location context for systems without a location determination device or in which a location determination device is not functioning. Further, this cookie may be used by systems to which a location determination device is attached, but for which a user prefers to use a fixed location context rather than a current location. Such cookies may also be re-used by other Web sites and other applications, and even across multiple devices.

Cookie header fields were originally designed to only be available to a site setting such a Cookie, however there are well known techniques in the field for making use of cross site Cookies, including redirection, a technique used by Microsoft, Inc., HTML <IMG> tag references, as used by DoubleClick, Inc. These techniques, coupled with the fact that such information is also recorded into a database along with a client IP address, allows for use of such information in any application with access to the database information.

In a Web based scenario, a Web server may, upon receiving a Web page request, extract a client IP address from the REMOTE_ADDR header field. Typically, such a field is of the form: REMOTE_ADDR=10.0.0.7. IP addresses determined from such header fields may be used as a basis for a search of a CPTable for recent entries that would indicate that a client is sending position updates. If such a search is successful, a server may thus realize the client has a location detection capability of its own and incorporate that location into activities at the site, such as location-based searches. If the search is unsuccessful, the server may then use a document cookie if it is present, or, upon receiving a location-based service request, such as a search for services, the present invention may prompt a user for geocoding or other manual means of location determination. If a user performs such manual location determination and decides to store the location context as the default, the server may then set a cookie to the recently entered location context. By way of example, with out intending to limit the present invention, a simple spatial Cookie may look like:

HTTP_{—}COOKIE=GEOS=38.922624%3A−077.222354

In this case, the cookie name is GEOS and it contains a latitude and longitude separated by a colon ‘:’ character which has been specially encoded as part of the HTTP protocol.

In a preferred embodiment, other information may be included as metadata, such as that describing formatting and other spatial information aspects. A preferred embodiment may also include other information such as that identifying other aspects of the client or the user, or include other Cookies that may relate to a spatial Cookie, or GeoCookie.

It is an object of the present invention to provide, along with these various means of location determination, a method for storing various location contexts so that a user of the system may effectively and efficiently manage multiple location contexts and store, recall, transmit, share, and use them in location based activities. To provide this functionality, the system may allow the inclusion of other information with the location context. Such information may include, but is not limited to, a name, descriptive text and range constraints, associated queries, content events, and automation. The present invention may provide user interface elements, such as hardware or software form fields, buttons, and dials, which can be use to store these geobookinarks and related digital information in a permanent storage, such as a local DS 112 or a remote DB 204 or DB206.

Additionally, the present invention can allow such items to be shared and transmitted as files or pointers to files via common communications means, such as E-mail, and shared access to common systems such as Web servers and FTP servers. The present invention may facilitate re-use, transmission, and sharing of geobookmarks and related events by defining a common geobookmark structure using modern methods and encodings. Such methods and encodings include, but are not limited to, MIME and XML documents and XML Document Type Definitions (“DTD's”).

As previously discussed, it is an object of the present invention to provide the use of location triggered or driven events and automation, such as reminders, multimedia events, and remote control through such geobookmarks. To facilitate such functionality, the present invention introduces the concept of an event queue (“EQ7”), as illustrated in FIG. 7. Such an event queue may be enhanced by an optional timing constraint mechanism, such as the “cron” function described later in this specification.

A user may utilize controls on UI 104 to associate location contexts with events such as multimedia recordings. For example, a user of the system who passes a grocery store while driving may mark the current location and record a reminder, such as “pick up milk and toothpaste.” In a preferred embodiment, UI 104 may have convenient, hardware or software control for marking the current location as a location context, along with default settings for a range of available options, and with an option to use this context or previously stored contexts as part of a location triggered event. Continuing the example, a user may mark the location, include a default range, and store a voice recording for the message “pick up milk and eggs.” This combination of location context and audio may be saved into the event queue.

The event being recorded is now a member of the event queue or list, perhaps with several other events. In one aspect of a preferred embodiment a process interacts with the queue by comparing a current client position with location contexts of items in a queue and activates items when a client reaches a proximity defined by location contexts, such as playing the reminder when the user returns by the grocery store.

Typically, a client will be within the location context of the events, at the instant they are created, and possibly for some time thereafter, until the client leaves the proximity. Since this is a common scenario, and it is undesirable to in this example immediately hear a reminder, the present invention provides for a UI 104 control and default behavior which may be set to first require the client to either leave the context before being activated or to wait for some time period to elapse prior to activating the event.

An additional aspect of the present invention may provide a flexible time constraint mechanism and specification ability to be included as an event constraint. This time mechanism may be one similar to the UNIX cron facility, outlined later, yet abstracted or made easier to use. Such a time mechanism may allow users to specify flexible timeframes, such as every minute or hour; or every Tuesday, Wednesday, and Saturday; or at 4:00 on Mondays, or after 5:00 PM on weekdays; thereby providing rich time-entry capabilities.

In alternative embodiments, a benefit may be derived by using various methods for comparing a queue, including by polling, callbacks, and interrupts, depending on the environment and use of the system. Those skilled in the arts of electronics and computer science should be readily aware of such methods.

In keeping with this, an aspect of the present invention also allows location-triggered events to interact with other systems over a network. For example, a user may choose to create a location context such as a range of five miles from their home, and to associate a time frame such as after 5:00 pm on weekdays, with an event to turn on the home air-conditioning and the walkway lights.

In other words, the present invention provides for the association of a location context and an optional timeframe, with a flexible set of events. To accomplish this, the present invention provides for the entry and association of contexts, events, and timeframes in a list such as represented by EQ7, in combination with a process that compares location contexts of list items with current client location information. Such client location information may be stored in CPTable, or may have been received with aforementioned transmission methods. The present invention may execute events, which may be represented in fields in EQ7 as process names, either locally or via a network when appropriate constraints are met.

For some events, such as those pertaining to home automation, interaction of the present invention and such events may be easily accomplished with those system and vendors providing standard or well defined and shared interfaces to their equipment, such as X10 home controllers. Other system integration may require custom programming or setup, or may not be possible if a vendor chooses to maintain an exclusive interface.

In addition to providing location-based control and automation, it is a further object of the present invention to provide for location based searches for business, services, products and other items, such as real estate, or network resources, such as printers and other devices, which may be nearby. Such network resources may be listed in a Directory or database, but due their dynamic nature may be more apt to utilize service location mechanisms and protocols such as those described later, including a publish and subscribe methodology or lookup, and discover and join functions provided by technologies such as the Jini Technology Platform, which is discussed later.

Such a directory should be well organized, and may contain items such as services, products, and other items for which a location context can be incorporated. For businesses and services, such an organization may be derived through the use of SIC codes, NAICS codes, and other industry classification codes, such as product codes and other useful classifications depending on the field.

In a preferred embodiment UI104 can provide some quick search capabilities for commonly searched for items by assigning commonly used items to user interface controls such as buttons, or creating custom lists and menus. For example, one aspect of preferred embodiment includes a quick find capability for emergency services, such as local police stations, hospitals, and fire departments, as well as a means for locating and interacting with nearby mobile emergency units such as patrol cars.

Such quick search capabilities can allow a mutable set of commonly searched for items to be more easily conducted by associating items such as ATM machines with a given button or dial, or in a short list or menu, including the storage of multiple sets or quick button and list configurations that may be recalled and used. For example, a person may wish to use a different quick list when in a different locality. Further, a preferred embodiment, along with review of and selection from a highly structured directory, allows custom search strings to be entered and searched for either separately or in conjunction with selections from directory categories. Such customization may be achieved using common user interface controls and methods, such as the Common Gateway Interface (CGI) or Dynamic HTML elements like Javascript, and through use of local and remote storage elements such as DS112 and DB204 or DB206. These interface controls and methods will be readily understood by those skilled in design of systems such as those employing modern Internet technologies. In a preferred embodiment, these quick menu items and buttons may be found by browsing a list of well defined categories, and then selected to be included in a set of common items, or quick list or menu.

A user may initiate a search for an item, such as services, via a user interface using the methods and hierarchy described for setting location context and methods to specify search criteria. A process, such as a process running on a System 100 device or remote server like DB 204, such as a Java program or CGI script initiated by or receiving the request, may then incorporate the location context and search criteria into a query for directory items.

In one aspect of a preferred embodiment, a directory may include organized and categorized items, and a location context. Such a location context may include a bounding polygon, such as a rectangle, thus being described by a bounding set of coordinates. Such a bounding polygon may be stored in a data table, such as service_directory, as illustrated in FIG. 8. Such a table may be stored in a database system such as DB 204, or DB 208, or may be organized in other ways, such as a directory rather than a table. In such instances, said directory may be stored in LDAP server DB 210.

In this manner, a search query, such as a SQL or set-logic query, may be conducted and yield a performance over other search methods. Such a query may take the form: “select * from service table where latitude>33 and latitude<34 and longitude>−77 and longitude<−76 and service_table.subclass=1.5.4.3”. Such a query may find all Notary Public service providers, or ATM machines, or whatever item is described by the service class or category, within a desired geographic area. The results of such a query may be returned to a client device as a list or map, with features for selecting either view or a combination of both views via controls on UI 104.

Armed with such directory-building features, the present invention can also provide directory validation capabilities. Currently, companies such as Verizon and Vindigo publish electronic directories, such as the Yellow Pages. Many of these systems share directory information, such as addresses, pertaining to various businesses and services listed therein. Thus, electronic directories at different websites or other locations may share a common source, or may be based in whole or in part on Government information, such as U.S. Census information. Companies such as Vindigo offer the ability to search for services close to a user, along with other features, such as allowing users of the system to help validate or add value, through features such as reviews.

However, in these models the directory information is not continuously checked, or verified by a system and there are often abuses by the users of the system which cause inaccurate information to be maintained by a directory, and consequently presented as the result of a search. For instance, a person disgruntled about service or a competitor of another service may make false entries about the quality of the service or even suggest that the business is no longer at that location.

The present invention provides a method for adding automatic directory validation through inclusion of merchant processing such as electronic cash registers, credit card processing equipment, and other point of sale (POS) equipment in the directory validation process. The present invention can generally determine that, if a merchant or POS transaction takes place at a given location, this is indicative that a merchant or service identified by a terminal ID is conducting business at the specified location at the time of a transaction. In a preferred embodiment, such a terminal may have System 100 capabilities, such as a built-in or attached location receiver or GLD 108 capability.

The present invention provides for a process for merchant transactions to initiate an electronic process which checks the directory listing of a merchant including location with the information from merchant transactions thus automatically validating the directory on a continuous basis rather than the common method of intervallic updates based on sales of advertisements or directory space as is currently used.

This is a general description meant to illustrate the method and not to limit the method. Although this method as described offers important benefits, there may be more sophisticated aspects in a preferred embodiment, depending on the circumstances, these aspects being added security, and features to not use every transaction as a validation if transactions are occurring in large volumes such as thousands per day or hour.

It is an object of the present invention to, once the system is aware of the network address of a client and its location context or associated location contexts such as a context being used by a system user for a search or other activity, to send location relevant content to the client such as advertising information. It is not essential, for a client to visit a Website or subscribe to a particular data stream in order to be sent this location related content. For instance in embodiments incorporating a stream such as an audio or video stream or both like those for convergent set-top boxes and television, or radio the content may be sent regardless of a visit to a particular network location or subscription to a network stream. Additionally, this content may be sent at any point that the system determines the IP address of the client, a therefore not be dependent on a client initiate an action such as a search or other action. One such method of address determination was described above using the CPTable and the continuous client send transmission method.

It is an aspect of the present invention to provide for a method of organizing or describing content with a location content, such as in a database table such as a Location Context Media Table, illustrated in FIG. 8, where media files are stored with along with a location context and other information such as the dimensions of the media like it's time duration or on screen dimensions and resolution. In this manner the location relevant content may be effectively distributed to clients over the network.

For example, in an embodiment using an Internet audio stream such as an Internet radio, if audio content such as advertisements are organized by location and also into standard time frames, such as 10 second intervals, then any combination of advertisements that fill an advertising time slot, such as three minutes may be used. That is to say, a three minute time slot may be filled by two one and a half minute ads, or by one three minute ad or by a one minute ad and a two minute ad or any combination that fits within the overall allotted advertising time or space. With this in mind, different clients at different locations may receive different location based advertisements while the client users are perhaps listening to the same audio stream such as a radio broadcast. Currently, with traditional radio the advertisers and their service points or stores are usually local to the station, which is usually a reasonably effective method for advertising as a station has a limited broadcast range. There are some extremes where a user many miles away or on one side of the broadcast range hears advertisements for businesses that are located moderately far away, or in the case of longer range stations, very far away including places they would never travel to. With the advent of network broadcasting such as Internet radio this inefficiency is amplified as a user may hear ads for businesses local to the station when they are in another country. The present invention provides for a more effective distribution of content such as ads, by including the location context of the user and providing for content substitution based on this criteria. So, for instance three users in different countries listening or viewing the same site, listening to the same audio, or watching the same video stream or channel at the same time or essentially the same time, can be presented with different content based on where they are located.

In one aspect of the present invention it is not necessary to have precise time slices for substitution, although this may be beneficial. That is it is still useful to use location determination without defining an absolute time granularity to the content. Having the knowledge of client or consumer location still provides greater precision than traditional methods. For instance a business may create multiple ads that are say 1 minute and 27 seconds with slightly different content such as references to different store locations in each ad, thus still affording a more focused content delivery or reception based on the client or users location.

In one aspect of the present invention the location relevant media may be incentives from vendors and merchants such as discounts on purchases or coupons. Such a functionality can be achieved in a simple sense, for example by a merchant including some method of identifying that the user or customer received a location based incentive such as a key word to use at the store location or point of sale. Or it is possible to use other devices in conjunction with a System 100 client device, such as a PDA to communicate with the client device, such as via extensible interface 114 which may be a USB port or infra-red communications, or similar link to transfer electronic coupons or other discounts or incentive items. It is an aspect of preferred embodiment to incorporate such functionality via extensible interface 114, user interface controls, and digital information delivered to the System 100 device via the network such as via network interface 110. To do so, such digital incentive information may be stored in a data table like LCMTable along with location context information. Additionally, such digital incentives may be delivered to the client as soon as the system becomes aware of the client's Internet address and location context. Another aspect of a preferred embodiment may not use a storage of such content in a table, but rather through a network transaction or communication with providers of digital incentives about the locations of clients and/or their network addresses. In a preferred embodiment both of these content delivery mechanisms may be utilized either separately or in conjunction.

As an example, there are now small portable devices which are essentially memory on the end of a USB connection containing as an example 32 megabytes of RAM, which are designed as a method of convenient portable storage. The devices can be quickly plugged into other electronic devices, and used to download and upload data. Additionally, with advances in technology there are other methods which will soon be common for easy and convenient exchange of digital data. In an example of a preferred embodiment, a client with an onboard GPS connects to the network such as in a vehicle. The location of the client device is communicated with a server using a previously described transmission method. This information is then stored in a table like CPTable. A process comparing client locations to location contexts in LCMTable determines that the client is within the location context of digital content in the table which is an electronic advertisement and coupon. The process then delivers this content to the client, which contains an incentive component. The user upon seeing or hearing the incentive on the multimedia device 106, or UI 104 of System 100, decides to utilize this incentive. Inserts a portable storage device such as the previously mentioned USB portable memory into extensible interface 114 and downloads the incentive. The user being close the location where the incentive was to be valid at, as would be the case since the content was delivered based on location context originally, enters the location and at the point of sale inserts the USB portable memory device in a point of sale terminal or device at the location intended for the receipt of digitally offered incentives, and this digital discount, coupon or other incentive is incorporated into the point of sale transaction.

In one aspect of a preferred embodiment, in order to capture the incentive from the UI to the portable storage in a basic scenario, the user of System 100 above, may have a visual display comprised of a software aspect such as a current Web browser technology, use a voice control, to stop temporarily the delivery of more content, and issue a command similar to “right clicking” in a modern Web browser, which results in a menu including a save option allowing storage to the plugged in media. In more sophisticated scenarios where some greater control and synchronization is required or desired, methods can be employed such as those provided for by the HyTime standard, ISO/IEC 10744:1992 and related technologies.

The following is an excerpt from “A Readers Guide to the HyTime Standard” (http://www.hytime.org/papers/htguide.html), by the editors of the standard, from the section “Hypermedia: Scheduling and Rendition” which briefly describes some capabilities:

The scheduling module of HyTime defines an architecture for the abstract representation of arbitrarily complex hypermedia structures, including music, interactive presentations, multi-track sequences, and so on. Its basic mechanism is a simple one: the sequencing of object containers along axes measured in temporal or spatial units.

In one aspect of a preferred embodiment these digital incentives may be acknowledged via system 100 with a control such as dial, button, or command such as a voice control via UI 104 and/or multimedia capability 106, and rather than having to be downloaded, the acknowledgement is recorded in a system such as a DB 204 with information identifying the user such as a digital certificate, like those provide by VeriSign, or via other authentication, and through means at the merchant's site for which the incentive is valid can utilize the acknowledged incentive, such as with a point of sale terminal with a network access capability.

It is an aspect of the present invention to use position as an aspect of content distribution, which may enable increased performance for the user and network providers. In the current Internet and content distribution infrastructure such as television and radio, content is delivered from everywhere to almost everywhere. Thus, as in the previous example of radio, television, and also with other methods such as Web pages, all the content may travel repeatedly from the distribution site to every user, even if many users are close to one area. However, with the present invention, by knowing the location of the destination point, the location relevant content may sent once instead of many times to a storage near the destination. This method provides a shorter path for the content to travel to the user or users, thus increasing performance such as download or transmission speed and simultaneously reduces the load on the transmission facilities and lines such as the expensive Internet backbone links and intermediate routers, switches, gateways and servers since the content may not have to repeatedly traverse the core infrastructure and instead can travel from the distribution point to nearby clients and users.

It is an object of the present invention to provide a spatial context for a variety of uses. In addition the type of user centric model presented above, spatial information can play important roles in fields like surveying, architecture, asset management, network management and telecommunications line costing which is calculated with a mileage component.

This discussion will describe some aspects of a more system centric approach and attempt to use network management including analysis and asset management, to illustrate the salient features of the present invention applicable to these environments.

Although it may seem at first glance easy for a business to be aware of assets such as computers, routers, switches and other network equipment, in practice it is not. As previously described the Internet and other networks do not presently have a location aspect to them. That is to say, even if a systems administrator may see equipment on the network they may be unable to find it's location and if it ceases to participate in the network they may have no record of it, or no record of its last location.

Asset management can begin to become difficult even in moderately sized networks of approximately just several hundred systems. One large site, such as a large company or government agency can easily have thousands of workstations, servers, and other equipment. The problem is even more amplified in large distributed systems such as major telecommunications providers which may have many thousands of routers alone distributed globally.

Although many systems include software management agents that allow custom text strings and identifiers to be entered such as an address or other location identifier, there are often flawed processes or time demands that cause the identifiers to not be entered, or because the fields typically allow free form typing, mistakes are made in the input and invalid data, are entered. In other scenarios a company may try to be proactive and enter the information before the device is shipped, but last minute changes in the destination of the device cause it to be installed in a location different that what is entered. Also, as network growth occurs, often in rapid manner, sometimes minor to massive shifts of network resources occur. For instance a network company or telecom company may be expanding globally and in order to simultaneously meet demand in one region or country, it may make significant upgrades to newer more powerful equipment in one area and shift the replaced assets to new countries or regions and any location information may again not be updated.

Additionally, although it may seem easy for a company to have a record of the sites or buildings in which assets are placed, some companies have thousands of locations with no standard identifications or addressing mechanism. Many companies, with the fast past of Internet growth are acquiring other companies who have different systems and ways to identify locations, and it is difficult for the integration of their disparate information sources.

Some companies, for example even very new BLEC's or in building LECs already have agreements that may have the company working with facilities comprising 5,10,15 or even 20% or more of the commercial real-estate in the U.S. and perhaps with a large number of international sites. These issues and others make accurate location of assets, in a rapidly changing environment, difficult and costly for these businesses.

The present invention provides a system and method for incorporating an assets location as identified by means other than just addresses, to aid in tracking of computing and network assets. To accomplish this the present invention provides for a means of incorporating the location technologies, transfer methods, and encodings that are discussed herein, into the management process thereby providing the ability to determine the location of assets connected to and not directly connected to the network.

One method of the present invention uses methods similar to those described for user centric systems, whereby a network device such as a router, or even a collection of devices, can determine their location via a single or shared connection to an automatic location determination device such as a GPS. These systems then via one of the methods outlined in the transmission methods interacts with a machine over the network to communicate the location information and the network address, which is thus associated and recorded in a table like CPTable. Such a recording of location and address may incorporate other information such as the time of the location determination and the method of position determination.

Another aspect of the present invention, which is not limited to the system centric method, but may be more common in these embodiments, is the packet header method.

As described earlier in transmission methods, it is an object of the present invention to use the Options fields of these protocols and other Internet protocols where possible, as a method for transmitting spatial information. Thus at intermediate and destination locations these packets may either be saved, or a sample may be saved, or additionally, they may be opened at intermediate or end points in order to extract the transmitted spatial information and associated network addresses.

In some scenarios the packets may be stored and analyzed outside of real-time, or the information may be extracted such as address and location and stored in a data table like CPTable.

It may also, be useful to utilize this method with lower level protocols wherein the packet or frame allows for, or even if it doesn't allow for, but may potentially not be disturbed by the inclusion of spatial information in the message or header. In some instances this information may be associated with physical addresses such as MAC addresses instead of or in combination with an IP address.

In one aspect of a preferred embodiment, this information such as network addresses, associated locations, and time may be used as an aid to network management including traffic management and geographical mapping of the network.

In one aspect of a preferred embodiment, one device such as a device with a system 100 capability, may use a wireless capability to recognize other devices nearby and associate its own location with these nearby elements and store or transmit this information using a transmission method like those previously described.

It is another aspect of the present invention to use characteristics of protocols, network routing methods, an physical media characteristics to infer the proximity to a location of some equipment without an attached GPS. That is to say, in the simplest sense a building may have a number of network nodes and devices, but it may have one main customer premise equipment (CPE) router or other device, that provides routes to the Internet via an Internet Service Provider (ISP). One aspect of the present invention may use the location of the router or switch providing service and associate that position with the network addresses of the devices for which it is providing routes to the network. This association may then be recorded or transmitted using any of the aforementioned transmission methods previously described. In these scenarios and in previously described methods the associated network address may be a physical layer address such as a MAC address in circumstances where those addresses can be ascertained, or other network addresses such as IP addresses.

It is an object of the present invention to provide for flexible configuration of SYSTEM 100 style clients and systems. In one aspect of a preferred invention a client/server management architecture is used such as is currently supported with the Simple Network Management Protocol (SNMP). Although, not limited to system centric methods it is more likely to be common in these uses.

There are a large number of documents and supporting standards and recommendations behind SNMP, however one key feature is the use of the Management Information Base or MIB. The MIB can be a confusing concept as it describes both an abstract mechanism and specific instances or implementations.

However, since the MIB essentially describes device components, and attributes and the interface to the values of those elements, and a method for reading them to determine device specific information, and a method for setting them to sometimes control configuration, it is valuable for devices with spatial attributes such as a known location to be able to have MIB elements that address these spatial aspects. For instance, if a device has spatial location entities such as current location coordinates, in the MIB then if that value is set in the device a remote management agent will be able to access those values, such values being perhaps updated by a built in system 100 capability using SNMPset commands, and retrieved using SNMPget commands. Additionally, earlier we described multiple transmission methods for spatial information including intervallic client send. Thus if a device has an spatial send interval MIB object, then a remote management agent may be able to alter this value to control the rate at which such a device sends spatial information to a server.

Thus, without getting to far a field into a somewhat complex area of discussion, it is an aspect of a preferred embodiment to define and/or utilize MIB objects like those just described for the management and interaction of devices with spatial characteristics or capabilities.

Some sample MIB objects, including spatial extension entries (the last five entries), listed in an inverse method organized by oid, may look like the following:

| | |
|---|---|
| “org” | “1.3” |
| “dod” | “1.3.6” |
| “internet” | “1.3.6.1” |
| “directory” | “1.3.6.1.1” |
| “mgmt” | “1.3.6.1.2” |
| “experimental” | “1.3.6.1.3” |
| “private” | “1.3.6.1.4” |
| “enterprises” | “1.3.6.1.4.1” |
| “near2” | “1.3.6.1.4.1.6046” |
| “device” | “1.3.6.1.4.1.6046.3.6” |
| “deviceType” | “1.3.6.1.4.1.6046.3.6.1” |
| “deviceVersion” | “1.3.6.1.4.1.6046.3.6.2” |
| “deviceId” | “1.3.6.1.4.1.6046.3.6.3” |
| “romVersion” | “1.3.6.1.4.1.6046.3.6.4” |
| “romSysVersion” | “1.3.6.1.4.1.6046.3.6.5” |
| “spatialTable” | “1.3.6.1.4.1.6046.3.6.11” |
| “spatialTransmissionMethod” | “1.3.6.1.4.1.6046.3.6.11.1” |
| “spatialTransmissionInterval” | “1.3.6.1.4.1.6046.3.6.11.2” |
| “spatialDescriptorType” | “1.3.6.1.4.1.6046.3.6.11.3” |
| “spatialMetadataTable” | “1.3.6.1.4.1.6046.3.6.11.20” |

It is an object of the present invention to provide a means for automatic configuration of client devices and systems at both initialization time (boot time) and/or at connect time (when connection to the network occurs via a functioning IP protocol stack) and to provide a means for these client devices to automatically join the spatial layer, or locate spatial services such as servers, ports and other objects over the wide area network (WAN), such as the Internet. To do so the present invention may incorporate the Dynamic Host Configuration Protocol (DHCP), sometimes referred to along with an earlier protocol the Bootstrap Protocol (BOOTP) or collectively DHCP/BOOTP; along with other service discovery and join capabilities like those provided by the Jini Connection Technology, Service Location Protocol and others either separately or in combination, including features for persistent naming over time and place via the incorporation and extension of services such as The Handle System (www.handle.net).

The general characteristics and standard use of the DHCP is fully described in RFC-2131. Simply stated in the abstract of the RFC-2131, “The Dynamic Host Configuration Protocol (DHCP) provides a framework for passing configuration information to hosts on a TCP/IP network. DHCP is based on the Bootstrap Protocol (BOOTP) [7], adding the capability of automatic allocation of reusable network addresses and additional configuration options [19]. DHCP captures the behavior of BOOTP relay agents [7, 23], and DHCP participants can interoperate with BOOTP participants [9]. Due to some errors introduced into RFC 1531 in the editorial process, this memo is reissued as RFC 1541. “Additionally from the introduction in section 1. “The Dynamic Host Configuration Protocol (DHCP) provides configuration parameters to Internet hosts. DHCP consists of two components: a protocol for delivering host-specific configuration parameters from a DHCP server to a host and a mechanism for allocation of network addresses to hosts. DHCP is built on a client-server model, where designated DHCP server hosts allocate network addresses and deliver configuration parameters to dynamically configured hosts.”

Several important aspects of DHCP are the ability to allow delivery of information to a client before it has an IP address using hardware addressing, the ability to send initialization code such as operating system images or executable code, and the extensibility of functions by using the DHCP options fields. Thus as the RFC states “DHCP allows, but does not require the configuration of client parameters not directly related to the IP protocol.”

Thus, it is an object of the present invention to use these features as part of providing a spatial context to the network. In particular, the system may use the inherent capability of DHCP to deliver code to clients which enable participation in spatial services, and other items such as the addresses of spatial servers and service providers within the DHCP options fields, thus providing an automatic configuration of the client for spatial activities and the automatic discovery of spatial servers and systems, reducing or eliminating the need for user intervention and configuration.

In present day networks whether enterprise or wide-area internetworking such as the Internet it may be difficult for a client system with or without a user to determine location of resources on the network. As one example Sun Microsystems, Inc. has developed a Java based software architecture called Jini to aid in service location primarily for the enterprise. The goal of Jini is to allow devices to seamlessly connect to the network and locate services on their own such as local printers. Indeed an example the use in the technical specification describes such a use.

Despite these intentions, there are still technical issues to be overcome, for instance in many offices there may be 500 printers on the second floor, so even if a device automatically finds printers on the second floor it may still be difficult for users to find a nearby service and associate a printer name with a particular physical device in order to choose it or know where their print jobs will end up.

Regardless, the Jini model offers some helpful features for a number of uses. These features are called lookup, discovery and join, which in a general sense allow a device to locate and join a Jini ‘federation’ of devices and resources and to both announce services they provide or to use announces services of other resources. This is a handy capability, especially as we move toward the network appliance age and the local area wireless age where devices may recognize a local resource over a wireless link such as provided by the new Bluetooth wireless standards.

Additionally the Jini model incorporates a transaction model, a leasing model and a flexible security model and an abstract approach to services that allow a service to be any object such as machine instructions such as Java code. Although, other means can be used to achieve these capabilities the Jini provides a core functionality that is useful as the bases for further discussion and a reference platform for this functionality.

Generally, though the Jini and other protocols such as Service Location Protocol are LAN oriented or enterprise (one business or company even if it is across sites, such as via a virtual private network (“VPN”).

However, it is possible through the use of methods including the dynamic configuration capabilities of DHCP, and/or persistent naming authorities such as the Handle system either separately or together to configure clients in a manner that they can locate spatial servers and services across the wide area network.

The Handle System is a persistent naming authority as described on the Systems' home Web page (http://www.handle.net):

“The Handle System is a comprehensive system for assigning, managing, and resolving persistent identifiers, known as “handles,” for digital objects and other resources on the Internet. Handles can be used as Uniform Resource Names(“URN's”).

The Handle System includes an open set of protocols, a namespace, and an implementation of the protocols. The protocols enable a distributed computer system to store handles of digital resources and resolve those handles into the information necessary to locate and access the resources. This associated information can be changed as needed to reflect the current state of the identified resource without changing the handle, thus allowing the name of the item to persist over changes of location and other state information. Combined with a centrally administered naming authority registration service, the Handle System provides a general purpose, distributed global naming service for the reliable management of information on networks over long periods of time.”

Such persistent naming provides a useful mechanism for storing persistent identifiers despite changes in location and time, which are related areas of the current invention. For instance, but not indented to limit the present invention, one use would be to store persistent handles for services such as pointers to location based service providers or servers to enable long term service location and other features, and to extend enterprise technologies into the Wide-Area Network realm.

Despite the value of such a system, and although the system is more rigorous and stable than general URL and DNS systems, it is an aspect of the present invention to incorporate other universal naming mechanisms to increase persistence. For instance, through carelessness, poor planning, or necessity handles can still be broken and moved around. It is an aspect of the present invention to add greater stability through the incorporation of other unique identification mechanisms such as company EIN numbers, or IANA private enterprise numbers which are immutable, into this or other naming mechanisms.

Thus, is an object of the present invention to leverage the capabilities of protocols and technologies such as DHCP, Jini Technology, Service Location Protocol, The Handle System and related technologies to provide for the auto-configuration of clients and auto-discovery of and participation in spatial services over a wide area network such as the Internet.

As an example without intending to limit the present invention, a client may connect to a network, and being originally set to dynamically determine its network configuration make a DHCPDISCOVER client broadcast request. A server then hearing the request may respond with a DHCPOFFER request offering configuration parameters, which may include by the nature of the protocol a boot image containing code, which in this scenario may include capabilities for participation in the spatial layer, or other configuration items which may help the client to locate a spatial service such as the IP address and possibly port of a server, or a persistent handle from a persistent naming authority that has additional configuration information such as code itself or pointers to such items, or service and/or server addresses. A typical DCHP client/server message exchange is illustrated in FIG. 13, which is extracted from page 15 of RFC-2131.

It is an object of the present invention to provide an architecture for the interchange and use of spatial information and information with spatial contexts supporting a spatial transaction and exchange which may include storage, transmission, conversion, analysis and other functions enabling the use of spatial information as part of electronic transactions for whatever transactions may have a use or be aided or benefited by the incorporation of such contexts or information.

As an example a company may have a list of environmental hazards, or perceived environmental hazards in the United States such as geographic information system with the coordinates or geographic descriptors for ground level radiation, radon levels, or power transmission facilities. In addition some other party such as a candidate to purchase land, or other real estate may wish to quickly evaluate any risk associated with their future purchase based on its location relevant to such hazards. It is an object of the present invention via the previously described methods such as service location, transmission methods, encoding methods and a rich metadata model to facilitate an electronic exchange for the seamless negotiation between owners of spatially relevant information and prospective users of such information to conduct spatially relevant transactions.

It is an aspect of a preferred embodiment to provide a publish and subscribe mechanism for certain spatial information transactions. As and example, a person may be interested in buying a home or real estate in a certain geographical area, say a given county. As is with the current real estate market, competition may be tough and their may be an advantage to knowing immediately when something comes available within an area. Thus, a person may subscribe to a notification service that compares the address of new properties as they become listed from various sources to a location context defined by a user and associates and event or several events such as to send them e-mail or voice mail or other notification when a new property meets the location context they have defined. In order, to better market such properties a real estate agency or association may choose to publish such information in a spatial exchange environment, or to otherwise allow this information to be utilized in such a manner.

To provide such a service, the present invention provides for a set of data tables or spatial object repositories, and processes for supporting these types of transactions on a publish and subscribe basis, which is a mechanism that will be understood by someone with skill in the art of computer science.

The present invention provides a means for using location contexts across disparate uses. There are many uses for spatial information such as finding services, products, landmarks, resources and relevant information. Although current systems require repeated entry of the same location information across uses, such as from one Website to another and even at the same site at each search or on return visits, the same information, when recorded, may be suitable to a plurality of uses and situations whether stationary or mobile. One reason for this missing cross functionality is due to a lack of common means for expressing location, some sites use zip code, some use address, city or state, some use shipping zones or other regional boundaries.

An additional object of the present invention is to extend current common information structures and standards to achieve an improved directory by adding spatial characteristics, object classes, and metadata. For example, the X.500 and LDAP directory standards include some foundation object classes that are collections of required and allowed attributes and standard attribute names, however there are no current object classes or attributes for expressing spatial information.

Common data formats and added information describing the content of the location information, such as what form it is in can help to achieve a more universal use. In a preferred embodiment the present invention incorporates and expands upon modern information standards including metadata and content standards including the use and/or extension of the standard LDAP Directory Object Classes, the definition of a Spatial Markup Language via and XML Document Type Definition, and the Content Standard for Geospatial Metadata (CSGM), along with supporting and extending a plurality of data formats, like various methods for specifying coordinates and references (multiple decimal and hour/minute/second encodings, NMEA strings, and others), multiple spatial reference systems including (geodetic, celestial, barycentric (gravicentic, such as the current International Celestial Reference Frame), multiple datums (WGS84, NAD27), multiple ellipsoid references, time reference systems (GMT, UTC, UT1, UT2, TAI(atomic time), Sideral) and standard file formats including SP3 and RINDEX.

It is an object of the present invention to utilize such standards, extensions, and metadata to facilitate use of spatial information across applications and systems, and to increase automation. For instance, if metadata are transmitted along with even simple spatial information, this increases the use and ability to automate. That is a system is much more able to decipher and use spatial information if it is aware that the information it is receiving is latitude and longitude and that the format is decimal with positive and negative used to specify east and west longitude, or that the information is a standard GPS/NMEA string.

Thus in a very simple form, in keeping with the previous description if a position string containing latitude and longitude began with a field header like ‘LATLON’ and a position identification string with an NMEA encoding began with a header of ‘NMEA’ a receiving system could process either string readily and extract the same information content from two different formats. This information about information is called metadata and it is an object of the present invention to support a rich metadata model and to add more value by through modern information standards and methods and extensions such as by specifying an LDAP spatialObject class, a SpatialXML, and with spatial extensions to the Management Information Base (MIB)

As outlined below from excerpts of their website the Federal Geographic Data Committee was chartered to set data standards like metadata standards for digital geospatial metadata in order to facilitate the use of such information and aid in things like determining the format of spatial information and its suitability to a particular task.

The FGDC website is located at (http://www.fgdc.gov) with a specific section on metadata.

In keeping with this the FGDC approved the Content Standard for Digital Geospatial Metadata (FGDC-STD-001-1998) in June 1998.

The next three paragraphs are excerpted from their Web site and offer some background.

The objectives of the standard are to provide a common set of terminology and definitions for the documentation of digital geospatial data. The standard establishes the names of data elements and compound elements (groups of data elements) to be used for these purposes, the definitions of these compound elements and data elements, and information about the values that are to be provided for the data elements.

The standard was developed from the perspective of defining the information required by a prospective user to determine the availability of a set of geospatial data, to determine the fitness the set of geospatial data for an intended use, to determine the means of accessing the set of geospatial data, and to successfully transfer the set of geospatial data. As such, the standard establishes the names of data elements and compound elements to be used for these purposes, the definitions of these data elements and compound elements, and information about the values that are to be provided for the data elements.

The standard does not specify the means by which this information is organized in a computer system or in a data transfer, nor the means by which this information is transmitted, communicated, or presented to the user.

Thus, it is recognized that the FGDC, has made steps to improve methods for working with spatial information. A review of the content standard (http://www.fgdc.gov/metadata/contstan.html) and supporting documentation reveals a rich set of information descriptors for describing the content, quality, condition, and other characteristics of data such as accuracy, lineage, distribution, availability and other aspects.

However, as mentioned in the last paragraph from the Web site excerpt, the standard does not really address some important aspects of the information for use in computer and other automated systems. By reading the standard and reviewing published spatial information published as adhering to the standard one can begin to see why this is so. For instance, although metadata may be present to describe the spatial information content, such as the distribution means or contact information, much of that information is encoded in a form meant for human consumption as was the intent. For example a National Imagery and Mapping Agency (NIMA) www.nima.mil, publication of “Precise Ephemeris and Clock Parameters” which contains information about the positions of GPS satellites and their orbits, has a field which is part of the metadata standard, called “Security Handling Instructions” has a value of “Call for more information”. Similarly other fields have information that is intended for humans rather than computers, which again was the stated intent.

However, by using this as a reference model, and incorporating some standard field values for terms, localities, description of availability times, machine interpretable instructions and references for items such as security, digital certificates, and other fields, a computer system or systems could indeed automatically begin to use this as a rich model for automated cross system and cross functional transmission, and application of spatial information.

Thus, it is an aspect of a preferred embodiment to extend such a base reference model with the items necessary to facilitate more machine centric, automatic, cross functional use of spatial information. For example, for a field such as “Update Frequency” or other time schedule description fields a method as discussed earlier using a cron format, could specify these schedules in a standard way such that a machine could automatically incorporate this information into its processing efforts, such as data collection.

The following sections discuss various information organization means, such as for including or expressing spatial features with LDAP and XML, which is followed by a description of time issues including accurate network time models an a timing or scheduling mechanism based on the UNIX cron facility that was used in prior descriptions.

In order to facilitate functionality and interoperability some common object classes and attributes have been established and/or adopted within LDAP implementations. These standard classes form a foundation supporting a basic common directory foundation and include object classes such as (Country, State, Locality, Person, Organization (as in agency or company), OrganizationalUnit (as in dept), OrganizationalPerson, telephoneNumber, Document, Service, etc).

These base objects provide a good set of objects for building upon. However, there is currently no object class addressing for providing a foundation for adding rich spatial descriptors and metadata to enable spatially oriented use of LDAP directories.

It is an object of the present invention to create such object classes including a primary class called spatialObject.

These spatial objectClasses are not fully described here. Yet it is an aspect of a preferred embodiment to define such objects and incorporate them in order to properly and accurately describe the spatial aspects of entries in and LDAP/X.500 style Directory repository.

However, as an example of such an object definition included here:

objectclass spatialObject

requires

objectClass

spatialObject

allows

simpleSpatialCoordinates

simpleSpatialCoordinatesType

fullSpatialDescriptor

fullSpatialDescriptorType

fullSpatialMetadataEntry

The Extensible Markup Language (XML) is the universal format for structured documents and data on the Web. For “structured data” think of such things as spreadsheets, address books, configuration parameters, financial transactions, technical drawings, etc. Programs that produce such data often also store it on disk, for which they can use either a binary format or a text format. The latter allows you, if necessary, to look at the data without the program that produced it. XML is a set of rules, guidelines, conventions, whatever you want to call them, for designing text formats for such data, in a way that produces files that are easy to generate and read (by a computer), that are unambiguous, and that avoid common pitfalls, such as lack of extensibility, lack of support for intemationalization/localization, and platform-dependency.

It is an aspect of the present invention to utilize XML in order to provide greater cross system use of spatial information and increased automation. For example the present invention may utilize XML to formulate and XML Document Type Definition or DTD describing common fields and structure for the exchange of spatial information. The present invention may define a SpatialXML for this purpose.

In its simplest form XML provides for methods of describing the content of information in a file, as opposed to HTML which provides a formatting or display language. A simple XML does not require and DTD and one can immediately use XML by placing worthwhile tags in a file that describe the content within them.

For instance a document containing and address may be arranged as follows:

<postaladdress>
<street>
1234 Albemarle Street
<street>
<city>
Alexandria
</city>
<state>
VA
</state>
</postataddress>

With such a structure it can be readily recognized by those familiar with computing systems, that it is relatively easy for a system to extract the address components from the file because the are described by their enclosing tags. This in contrast to an HTML table with the same information:

<html>
<body>
<table>
<tr>
<th>street</th>
<th>city</th>
<th>state</th>
<tr>
<td>1234 Albemarle Street</td>
<td>Alexandria</th>
<td>VA</th>
<tr>
</table>
</body>
</html>

From which it can be seen that the tags do not describe the content, but merely there position in a table, thus making it hard to rely on such a method for the accurate determination of the content and thus ability to make use of it in a sophisticated, automated fashion.

In a spatial scenario even basic XML could be used to begin to describe spatially relevant information such as with:

<spatialObject>
<objectType>
machine
<objectType>
<spatialCoordinates method=latlon>
<latitude>39.354</latitude>
<longitude>−77.50</longitude>
</spatialCoordiates>
</spatialObject>

In this case, a system could easily extract important information about the listed object, such as its location. In practice this is not a great design. However it is used here for general illustrative purpose.

It is an aspect of preferred embodiment to incorporate such mechanisms, such as the definition of a spatialXML, and/or a geobookmarkXML to increase the cross functional, cross system use and automation of systems designed for, or with a need to make use of spatial information.

Accurate time keeping and time systems are an integral part of systems that determine and use spatial location. In a pure technical sense, time determines place. All spatial reference systems are closely related to precision time methods, and there are a number of time references including the deprecated Greenwich Mean Time (GMT), its replacement Universal Coordinated Time (“UTC”), UT or UT1, UT2. and many others which are described briefly on the U.S. Naval Observatory Site (http://tycho.usno.navy.mil/systime.html).

In any case, it is an aspect of the present invention to support a plurality of spatial systems, which means that in some scenarios it is worthwhile to support the of an accurate time reference model. Additionally, there are other common beneficial uses for reasonably accurate time related to any robust system.

Fortunately there is an accurate network time keeping and coordination method called simply Network Time Protocol (NTP) as described in RFC1305 and implemented in readily available software and publicly and privately available systems with accurate time references, like stratum 1 time sources as described in the RFC. NTP includes sophisticated means for accounting for factors such as network delay when transmitting and coordinating time between systems.

It is aspect of a preferred embodiment to support a plurality of time reference systems and to incorporate accurate time mechanisms which may including systems with attached hardware such as time signal receivers, like GPS receivers, and network time methods such as NTP where applicable.

Many aspects and benefits of the present invention can be realized without such time references, however there are aspects and applications that benefit from such capabilities.

It is a common feature on most systems with a UNIX based operating system to include a functionality called cron or cron jobs. A preferred embodiment of the present invention may incorporate time constraints in conjunction with location contexts and automation such as reminders and remote control.

This cron method is used to illustrate a method that may be used in a preferred embodiment for specifying such time constraints, and to aid in the description of how such scheduling may be accomplished, yet it is not intended to limit the invention to this method.

A crontab file or table consists of lines of six fields each. The fields are separated by spaces or tabs. The first five are integer patterns that specify the following: minute (0-59), hour (0-23), day of the month (1-31), month of the year (1-12), day of the week (0-6 with 0=Sunday).

The sixth field of a line in a crontab file is a string which is usually a command that is executed by the operating system. In these examples, the string is the word ‘date’ which can be ignored, as this particular discussion is merely meant to illustrate a method for specifying scheduling or time constraints.

Some typical cron table entries.

# MIN HOUR DAY MONTH DAYOFWEEK COMMAND

# at 6:10 a.m. every day

10 6***date

# every two hours at the top of the hour

0*/2***date

# every two hours from 11:00 p.m. to 7:00 a.m., and at 8:00 a.m.

0 23-7/2,8***date

1. A method of creating graphical network maps, comprising the steps of:
determining the spatial location of a device;
embedding said device spatial location in data transmitted from said device;
determining spatial locations of at least one network device through which said data passes;
modifying packet information associated with said data to include said network device spatial locations; and,
receiving said modified packet and extracting said spatial locations; and
illustrating said geographic locations on a map or by other graphical means.

2. A spatial information transmission method for use within and between electronic devices, comprising the steps of:
obtaining an automatically determined spatial location from an electronic device when said electronic device is capable of such determination;
obtaining a spatial location from a user when said electronic device is not capable of automatic spatial location determination and said stored spatial location is not available from said electronic device; and
embedding at least one of said spatial locations in communications originating from said electronic device.

3. The spatial information transmission method of claim 2, further comprising the step of obtaining a stored spatial location from said electronic device when said electronic device is not capable of automatic spatial location determination;

4. The spatial information transmission method of claim 2, further comprising the step of storing at least one of said spatial locations, wherein said at least one stored spatial location is made available to a plurality of requesters.

5. The spatial information transmission method of claim 2, wherein said spatial locations include spatial location information and spatial location attributes.

6. The spatial information transmission method of claim 2, wherein said spatial location is embedded using Multi-purpose Internet Mail Extensions.

7. The spatial information transmission method of claim 2, wherein said spatial location is included in object identifiers in a Simple Network Management Protocol management information base.

8. The spatial information transmission method of claim 2, wherein said spatial location is included as a Lightweight Directory Access Protocol object.

9. The spatial information transmission method of claim 2, wherein said spatial location is embedded within the header of a standard Advanced Research Projects Agency Internet Text Message.

10. The spatial information transmission method of claim 2, further comprising the step of encoding said spatial location based on an Extensible Markup Language Document Type Definition.

11. A spatial location based reminder method, comprising the steps of:
storing content;
defining a spatial region;
allowing a user to associate said spatial region with said content;
determining a current spatial location of an electronic device; and
presenting content associated with a spatial area to a user when said device is within said spatial region.

12. The spatial location based reminder method of claim 11, in which said electronic device performs said step of determining said current spatial location.

13. The spatial location based reminder method of claim 11, in which said spatial region is defined by a spatial location occupied by the device on which said association is created, wherein said spatial region is determined by associating a range with said spatial location.

14. The spatial location based reminder method of claim 11, in which said content is stored on at least one server communicatively coupled to said electronic device.

15. The spatial location based reminder method of claim 11, in which said defined spatial regions are stored on at least one server communicatively coupled to said electronic device.

16. The spatial location based reminder method of claim 11, in which said spatial region and content associations are stored on at least one server communicatively coupled to said electronic device.

17. A spatial location based control method, comprising the steps of:
creating a command to control a device or system;
defining a spatial region;
associating said spatial region with said device or system control command;
determining a current spatial location of a mobile electronic device; and
sending the device or system control command associated with a spatial region to a device when said mobile electronic device is within said spatial region.

18. The spatial location based control method of claim 17, in which said device or system control command is sent when said mobile electronic device enters said spatial region.

19. The spatial location based control method of claim 17, further comprising the steps of:
associating scheduling information with said spatial region and control command associations; and,
restricting the sending of device or system control commands associated with said spatial region to dates and times corresponding to said schedule information.

20. The spatial location based control method of claim 17, in which said mobile electronic device determines its current spatial location.

21. The spatial location based control method of claim 20, in which said spatial region definition step further comprises activating a user interface element on said electronic device which causes a spatial location to be recorded and associated with a range to create said spatial region.

22. A spatial location based information display and control system which includes a means for defining a user selectable hierarchy of one or more preferred location determination means, wherein said user selectable hierarchy allows users of said spatial location based information display and control system to record spatial locations of interest using a variety of spatial location specification means.

23. A spatial location based content substitution method, comprising the steps of:
storing content in a database;
storing attributes of said content in said database;
associating said content with one or more spatial locations;
storing said associations in a database;
determining the current spatial location of a content presentation device;
selecting content from said database based on said content presentation device current location and content attributes; and,
presenting said content to a user of said content presentation device in place of default content.

24. The spatial location based content substitution method of claim 23, further comprising the step of selecting content from said database based on a current date and time, and user behavior patterns.

25. The spatial location based content substitution method of claim 24, in which said behavior patterns include the duration a user typically stays within a spatial region, and the frequency with which a user visits a given spatial region.

26. The spatial location based content substitution method of claim 23, in which said content attributes include content duration and content target audience.

27. The spatial location based content substitution method of claim 26, in which demographic information relating to a user or owner of said content presentation device is stored in a database, and wherein such demographic information is used in combination with other criteria when selecting content from said database.

28. The spatial location based content substitution method of claim 23, in which said content and said default content includes advertisements.

29. The spatial location based content substitution method of claim 23, in which the step of selecting content from said database includes selection of one or more content pieces whose aggregate dimensions are substantially equal to said default content.

30. A spatial location transmission method, comprising the steps of:
determining a spatial location of interest;
determining spatial location attributes;
translating said spatial location of interest and spatial location attributes into at least one standardized format; and
embedding said translated spatial location into at least one communications protocol component.

31. The spatial location transmission method of claim 30, in which said communications protocol components comprise communications protocol headers.

32. The spatial location transmission method of claim 31, in which said embedded, translated spatial locations are transmitted as part of all data transmitted by a device.

33. The spatial location transmission method of claim 30, in which said at least one communications protocol is comprised of at least one message transfer protocol.

34. The spatial location transmission method of claim 30, in which said spatial location of interest comprises the current spatial location of a device.

35. The spatial location transmission method of claim 34, in which said current spatial location of a device is determined automatically.

36. The spatial location transmission method of claim 30, in which said spatial location attributes utilize the Content Standard for Digital Geospatial Metadata as said standardized format.

37. The spatial location transmission method of claim 30, in which said standardized format is enhanced to use a standardized vocabulary, thereby facilitating additional automation.

38. The spatial location transmission method of claim 30, in which additional translated spatial locations indicating the current spatial location of network components devices said data transmitted by a device are embedded by said network components into said data.

39. The spatial location transmission method of claim 30, further comprising a step of maintaining a database of previous and current spatial locations for various devices, thereby enhancing asset management capabilities.

40. A spatial location based data validation system, comprising:
a transmitting device capable of automatic spatial location determination;
a receiving device capable of receiving a spatial location;
a database of recent transmitting device spatial locations;
a means of calculating a speed and direction of said transmitting device based on said database of recent transmitting device spatial locations; and
a means of determining whether a most recently received transmitting device spatial location is consistent with said calculated speed and direction, within a specified range.

41. A spatial location based data validation method, comprising the steps of:
determining the current spatial location of a transmitting device;
transmitting said transmitting device current location to a receiving device along with other data from said transmitting device;
receiving said transmitting device current spatial location;
storing said transmitting device current spatial location;
calculating the speed and direction of travel associated with said transmitting device based on recently stored current spatial locations for a transmitting device;
determining whether said transmitting device current location is consistent with said calculated transmitting device speed and direction of travel, within a customizable error limit; and
providing positive authentication to said other data from said transmitting device if said transmitting device current spatial location is determined to be consistent with said calculated transmitting device speed and direction of travel.

42. An automatic spatial location client configuration and service location system, comprising:
a device capable of transmitting a configuration request and receiving local configuration information;
a storage means on said device into which said local configuration information can be stored;
at least one server capable of fulfilling computing services; and
at least one master server capable of maintaining a list of currently available services provided by said at least one server, spatial locations associated with said at least one server and said device, and spatial locations served by said at least one server.

43. The automatic spatial location client configuration and service location system of claim 42, wherein said device includes a current spatial location in said configuration request.

44. The automatic spatial location client configuration and service location system of claim 42, wherein said local configuration information received by said device includes a spatial location.

45. The automatic spatial location client configuration and service location system of claim 42, wherein said local configuration information includes software to be installed on said device.

46. The automatic spatial location client configuration and service location system of claim 42, wherein said local configuration information includes specification of a preferred spatial location encoding means and software necessary to implement said preferred spatial location encoding means if said device is not already capable of implementing said preferred spatial location encoding means.

47. An automated network client configuration and service location method, comprising the steps of:
transmitting a configuration request from a device;
receiving and processing said configuration request at a master configuration server;
identifying at least one server capable of providing said requested configuration information to said device based in part on said spatial location transmitted by said device;
rerouting of said configuration request to said at least one service server;
transmitting said requested configuration information to said device from said at least one service server; and
storing said requested configuration information on said device.

48. The automated network client configuration and service location method of claim 47, in which said configuration request includes a spatial location, attributes associated with said spatial location, and attributes associated with said device

49. The automated network client configuration and service location method of claim 47, in which said requested configuration information includes a list of additional services available from at least one server accessible via the network.

50. The automated network client configuration and service location method of claim 47, in which said device is capable of automatically determining a current spatial location, and said current spatial location is included in said configuration information request.

51. A real time, spatial location aware directory system, comprising:
an electronic device which is assigned a unique identifier, and which is capable of reporting a spatial location by embedding said spatial location, said unique identifier, and other information within communications originating from said electronic device;
network infrastructure equipment capable of extracting said spatial location and said unique identifier from said communications originating from said electronic device;
a database communicatively coupled to said network infrastructure equipment which is capable of associating said extracted electronic device identifier and spatial location with information pertaining to an entity owning and operating said electronic device; and
a means of updating spatial location information stored in said database when spatial location information reported by said electronic device changes.

52. The real time, spatial location aware directory system of claim 51, wherein said electronic device includes a point of sale terminal.

53. The real time, spatial location aware directory system of claim 51, wherein said information pertaining to an entity owning and operating said electronic device includes the name, address, telephone number, and E-mail address of said entity, wherein said address is updated as said spatial location information reported by said electronic device changes.

54. A method of maintaining a real time, spatial location aware directory which comprises the steps of:
embedding at least one spatial location and attributes associated with an electronic device in communications originating from said electronic device;
monitoring said communications and extracting said spatial location and attributes;
storing said extracted spatial location and attribute information in a database of entities owning said electronic devices, along with additional information provided by said entities; and,
updating said database when said spatial location associated with said electronic device changes.

55. The real time spatial location aware directory maintenance method of claim 54, in which said electronic device is a point of sale terminal.

56. The real time spatial location aware directory maintenance method of claim 54, in which said additional information includes the name, address, telephone number, and E-mail address of said entity, wherein said address is updated as said spatial location associated with said electronic device changes.

57. A method of storing a spatial location associated with a given waypoint, comprising:
determining a spatial location;
translating said spatial location into at least one standardized format; and
storing said translated spatial location as a cookie.

58. A method of building an enhanced directory of available services and devices which includes the spatial location of such services and devices, comprising the steps of:
transmitting a configuration request from a device, wherein said configuration request includes a spatial location, attributes associated with said spatial location, and attributes associated with said device;
receiving and processing said configuration request at a master configuration server;
identifying at least one service servers capable of providing said requested configuration information to said device based in part on said spatial location transmitted by said device;
rerouting of said configuration request to said one or more service servers;
transmitting said requested configuration information to said device from said one or more service servers;
storing said requested configuration information on said device.
storing said spatial location, spatial location attributes, device attributes, and assigned configuration information in a database on a server;
allowing other devices to search said database; and,
updating device spatial location and spatial location attribute information on a periodic basis.
